(19) United States
(12) Patent Application Publication
(10) Pub. No.: US 2022/0212779 A1
(43) Pub. Date: Jul. 7, 2022

(54) VARIABLE-SPAN WING AND ASSOCIATED AIRCRAFT

(71) Applicants: Ryan Michael RANDALL, Tucson, AZ (US); Chunmei CHEN, Qingdao, Shandong (CN); QINGDAO RANDALL AERODYNAMICS ENGINEERING, LLC, Qingdao, Shandong (CN)

(72) Inventors: Ryan Michael RANDALL, Tucson, AZ (US); Chunmei CHEN, Qingdao (CN)

(73) Assignee: RANDALL AERODYNAMIC ENGINEERING, GUANGZHOU, LLC, Guangzhou, Guangdong (CN)

(21) Appl. No.: 17/638,546

(22) PCT Filed: Aug. 26, 2019
(86) PCT No.: PCT/CN2019/102471

§ 371 Date: Feb. 25, 2022

(51) Int. Cl. B64C 3/54; B64C 39/02

(52) U.S. Cl. CPC B64C 3/54; B64C 2201/102; B64C 2201/021; B64C 39/024

(57) ABSTRACT

Adaptive wing systems and aircraft. A variable-span wing for aircraft comprises a fixed-section (1) with skin (118) that forms a lift-generating wing surface, and further comprises a top and a bottom moveable section (2) that are vertically offset from one-another and which translate in substantially lateral directions into and out of the fixed-section (1) through fixed-section tip-openings (126). The moveable sections (2) overlap inside of the fixed-section (1) when fully retracted. The wing also comprises at least two tracks (310,316) and track-mating parts (320). The track-mating parts (320) are attached near the roots of the moveable sections (2) and translate along the tracks (310,316) to guide the moveable sections (2). A non-overlapped wing with motors (331) that translate with the moveable sections (2) and which have attached gear heads (332). A rack (341) is located within the fixed section (1). Rotation of the gear heads (332) against the rack (341) causes the moveable sections (2) to translate. A non-overlapped wing having two disc-like elements (334) and a loop-like element (343) around the disc-like elements (334). Rotation of a disc-like element (334) causes the loop-like element (343) to push-and-pull the moveable sections (2) in opposing directions into and out of the fixed section (1). An aircraft utilizing the first-described wing having a propulsion system (8) and a set of elevons (5).

### FIELD OF INVENTION

The present invention relates to the fields of adaptive wing systems and aircraft.

### DESCRIPTION OF RELATED ART

### Motivation

Small unmanned aircraft have many private and commercial applications. They are used as aerial sensor platforms (i.e. video-acquisition), delivery systems, and communication relays. Public sector applications include: search and rescue, border security, law enforcement, and environmental monitoring. An aircraft can be classified based on its method of aerodynamic lift generation as: fixed-wing, rotary-wing, hybrid, or flapping-wing.

It is desirable to have one aircraft which is versatile enough to be used in many ways, in many places, for long flight times, and over a wide range of speeds. Hybrid aircraft can combine the advantages of fixed and rotary wing craft allowing them to successfully perform tasks that neither a fixed nor a rotary wing aircraft could. The most promising type is the vertical-takeoff-and-landing (VTOL) fixed-wing aircraft, which has been gaining popularity in the commercial and hobbyist markets. These craft do not require a runway, can fly quickly and efficiently to a distant location, fly lowly-and-slowly at that location, and after the flight objectives are achieved the aircraft can fly quickly and efficiently back to the user.

To achieve efficient long range and long endurance flight it is desirable to employ a wing with a high aspect ratio. Unfortunately, high aspect ratio fixed-wing hybrids are gust-sensitive, especially when positioned broadside to the wind and flying at low speeds or hovering. Previous designers have successfully designed VTOL aircraft with reasonably high aspect ratios using quad-rotor technology for stability. One method is to use a “jump” quad-rotor hybrid UAV (i.e. Latitude Engineering's HQ-90), a tilt quad-rotor hybrid (i.e. Quantum Systems TRON), or a “tail-sitter” quad-rotor hybrid (e.g. Xcraft X PLUSONE, Aerovironment Quantix, and Swift 020). These vehicles take advantage of the relative simplicity and low cost of quad-rotor technology and apply it to otherwise traditional fixed-wing aircraft designs.

With regard to quad-rotor technology depending upon four motors can reduce safety and reliability. A crash will result if one motor fails during flight. Furthermore, using four motors implies that the motors will be smaller than would be the case had two motors been used; smaller motors are typically less energy efficient. Similarly, using four propellers implies that each propeller will be smaller than would be the case had two propellers been used. The efficiency of small propellers is sensitive to Reynolds number, so shrinking a small propeller will reduce its aerodynamic efficiency all-else held constant.

Gust-sensitivity is a problem that can be alleviated by using a low aspect ratio wing, which allows an aircraft to fly in moderate winds without requiring four separate motors and propellers positioned far away from one-another. A low aspect ratio fixed-wing tail-sitter can maintain stability while hovering in low-to-moderate winds. It can also fly very quickly and efficiently relative to traditional helicopters and multi-rotors. An added benefit is that low aspect ratio wings have short wingspans, which makes them easy to store and transport. Low aspect ratio tail-sitters typically use propellers in a tractor configuration (ahead of the wing) such that one or more propulsive slipstreams flow over control surfaces to maintain control during hover. An example of this is the XK X520, which utilizes symmetric airfoils. Symmetric airfoils provide a simple solution to the problem of pitching and drifting during hover but cambered airfoils are more efficient during conventional flight. The only low aspect ratio fixed-wing tail-sitter that utilizes cambered airfoils, to the author's knowledge, has been patented by the present author. It is called “Examiner”. Examiner has a unique patented control system.

Unfortunately, a low aspect ratio wing is typically less aerodynamically efficient than a high aspect ratio wing, which ultimately limits flight endurance and/or range. There are other ways to avoid using multiple motors for hovering stability while using a reasonably high aspect ratio wing. There is a fixed-wing tail-sitter UAV design under development by DARPA, called “Tern”. It utilizes centerline propulsion, unlike almost all other hover-capable tail-sitter fixed-wings. Tern's wing also has a high aspect ratio. Unlike other tail-sitter fixed-wing designs Tern doesn't use propellers, it uses rotor blades (can cyclically vary blade pitch), which allow Tern to hover and be controlled like a helicopter. The rotor blades are extremely long which results in a large slipstream that helps to prevent wing-stall. Unfortunately, the coaxial rotor-blade solution is complex and expensive for commercial and hobbyist markets.

The novel aircraft presented herein solves all of the aforementioned problems. It is a VTOL, tail-sitting, fixed-wing aircraft that utilizes two motors and propellers. The aircraft's novel variable-span wing allows it to enjoy the advantages of having a low aspect ratio wing AND the advantages of having a high aspect ratio wing without the disadvantages of either.

### Variable-Span Wing

Existing adaptive wing systems change the shape of a wing to produce a desired effect. Examples include: rotating a wing about a hinge to keep it inside of a Mach cone, actively twisting a wing to induce a rolling moment, changing trailing edge camber to control pitch, and many others. Generally the physical size and planform area of a wing are either unchanged or little-affected. As a result, existing adaptive wing systems tend to produce only subtle effects and marginal benefits over traditional control systems (e.g. flaps, leading-edge slats, etc.).

Adaptive wing systems have existed since the Wright Brothers designed wing-warping as a means of roll control to execute sharper turns. Wing-warping avoided small aerodynamic losses associated with small gaps and sudden changes in the shape of a wing. Nonetheless, wing-warping has been entirely replaced by the flapped wing (ailerons), which was invented by Glenn Curtis. Flapped wings are significantly simpler and cheaper. Modern adaptive-wing systems typically have similar complexity and cost-versus-benefit problems, which mostly limits their use to military markets.

Flexible adaptive-compliant systems can provide marginal gust-alleviation and can change the camber of a wing near its trailing edges such that flaps become unnecessary for rotational control. As a result, sudden cross-sectional changes and gaps that are common to traditional flapped-wing systems are avoided and a slight improvement in aerodynamic efficiency is realized. These systems are seldom used.

The Parker variable-wing for biplanes has an upper wing that is flexible such that its camber will increase as the rigid lower wing stalls. An increase in lift and a decrease in aircraft stall speed was achieved. Biplanes have fallen out-of-favor as a result of advances in materials and structures. Monoplanes are the vast majority of planes in-use today.

Other modern adaptive-wing systems have been designed using combinations of flaps to promote desired aeroelastic effects while negating undesired effects. A simple example is the simultaneous deployment of leading-edge slats with ailerons to prevent unbalanced wing-torsion about a structural spar. These systems are relatively simple, inexpensive, and useful, but the effect-magnitude is limited by their inability to significantly change wing aspect ratio or planform area.

A successful modern example of an adaptive-wing system is the variable-sweep system, or “swing-wing” system. These systems allow an aircraft to fly more slowly during subsonic flight while keeping wings within the Mach cone during supersonic flight. Unsurprisingly, variable-sweep wings are typically used on fighterjets, like the USAF F-14 “Tomcat”. There are other aerodynamic benefits, like more efficient flight over a wider range of speeds. Swing-wing aircraft can achieve higher maximum speeds, lower stall speeds, and can make an aircraft more compact than it would be otherwise. Some disadvantages include stress concentration at hinges, which requires hinges to be very strong—and heavy. The most critical wing-defining parameters are aspect ratio (related to wingspan) and wing planform area, both of which have profound effects on aerodynamics. As a variable-sweep wing “swings” its aspect ratio changes significantly, but its planform area changes only slightly. An adaptive wing system that could significantly change aspect ratio AND planform area would have profound effects.

Previous designers have created variable-span wings with limited success. Examples include the Aerovisions “Droid of Death”, which is a flying-wing aircraft with two telescoping moveable sections per semi-span and one fixed-section. Another variable-span system was invented by David Gevers for a conventional manned airplane, which had a fixed section and two moveable sections (U.S. Pat. Nos. 5,645,250, 5,850,990). Others include the Telecope Flugel and GNATSpar wing. A delta wing with straight (no sweep) moveable sections was created by students at Virginia tech, and small telescopic span extensions were added to the HALE UAV. The amount of wing span, wing area, and aspect ratio could theoretically, at most, double. None of these systems were applied to a vertical takeoff and landing aircraft.

The internal volume of aircraft wings can be utilized for fuel storage, or to place components like batteries, servos, sensors, and other equipment. Cut-outs covered by removable panels are typically used to access wing-stored components. Unfortunately, the cut-outs cause stress concentrations and weaken the structure of the wing and skin. As a result, structural reinforcement is needed, which increases cost and weight while reducing range.

The variable-span wing disclosed herein solves all of the aforementioned problems. A new general method for installing and accessing parts within a fixed-wing is introduced which allows an assembly of parts to be installed and removed through an opening at the tip of a wing-section without utilizing any cut-outs or panels. The variable-span wing allows a vehicle to have a short wingspan with a low aspect ratio during periods of hover and VTOL, while enjoying the benefits of a long wing and high aspect ratio during conventional subsonic flight. It also provides higher dash speeds and a wider range of efficient cruise speeds. The moveable sections are stored within a central fixed-section that utilizes airfoils and is an effective lift-generating wing-surface, rather than using an unproductive fuselage or storage compartment that is mostly non-lifting. Unlike existing variable-span systems the variable-span wing disclosed herein allows aspect ratio and planform area to theoretically triple between the fully-contracted and fully-extended conditions because its moveable sections are vertically-offset from one-another and overlap. Novel and unique actuation systems for the moveable sections are proposed and presented that are relatively simple and inexpensive as-compared to existing systems. Implications on achievable new combinations of aircraft qualities are profound, including: overall aircraft performance, maneuvering capability, versatility of use, efficient flight speed range, and storable aircraft quantity.

### BRIEF SUMMARY OF THE INVENTION

The variable-span wing is depicted in FIG. 1 with its moveable sections (2) fully-extended and in FIG. 2 with its moveable sections (2) fully retracted. The variable-span wing for aircraft comprises a fixed-section (1). The fixed-section (1) further comprises fixed-section skin (118). The fixed-section skin (118) forms a lift-generating wing surface. The fixed section (1) also comprises fixed-section airfoils (103), as seen in FIG. 3, where some of the fixed-section airfoils comprise a round leading edge (104) and a relatively sharp trailing edge (105). A close-up of the interface between the fixed and moveable sections is provided in FIG. 4. The fixed-section comprises a left tip, where the left tip comprises a tip-opening (126), as seen in FIG. 5. Similarly, the fixed-section (1) comprises a right tip, where the right tip comprises a tip-opening (126).

The variable span wing also comprises a top and a bottom moveable section (2), as depicted in FIG. 6. Each movable section comprises moveable-section airfoils (203), as in FIG. 3B, where some of the moveable-section airfoils (203) comprise a round leading edge (204) and a relatively sharp trailing edge (205). The two moveable sections (2) are vertically offset from one another, as shown in FIG. 7 looking inward from the left tip-opening. The top moveable section translates in substantially lateral directions through one of the tip-openings (126) into and out of the fixed-section (1). The bottom moveable section translates in substantially lateral directions through the other tip-opening (126) into and out of the fixed-section (1). The two movable sections (2) overlap each other within the fixed-section (1) when fully retracted.

The variable span wing also comprises a set of sliding mechanisms designed to facilitate the two moveable sections (2) to translate in substantially lateral directions into and out of the fixed-section (1). The set of sliding mechanisms comprise at least two tracks (310) and at least two track-mating parts (320). Each track (310) is located within the fixed-section (1) and does not translate with the two moveable sections (2). At least one of the track-mating parts (320) is attached near the root of the top moveable section (2) and translates along at least one of the tracks (310) to guide translation of the top movable section (2). At least one of the track-mating parts (320) is attached near the root of the bottom moveable section (2) and translates along at least one of the tracks (310) to guide translation of the bottom movable section (2).

It is recommended that at least some fixed-section airfoils (103) have a maximum thickness (106) greater than 6% of chord-length (107), and have a maximum thickness (106) greater than that of moveable section (2) airfoils (203), as seen in FIG. 3B. It is further recommended that at least some moveable-section airfoils (203) have a chord-length (207) between 30 and 70% of the mean geometric chord-length (107) of the fixed-section (1) airfoils (103). Each moveable section (2) when in a fully extended position should have geometry that falls within the following angular magnitude limits: dihedral (124)≤3 degrees, washout≤5 degrees, and leading-edge sweep (123)≤6 degrees.

The variable-span wing for aircraft may further comprise a left and a right end cover (4), as shown in FIG. 4. Each end cover (4) comprises an end cover hole (401). The left end cover (4) is located over the left tip opening (126, FIG. 5) of the fixed-section (1). The right end cover (4) is located over the right tip opening (126) of the fixed-section (1). Each end cover hole (401) is sized and shaped to allow one of the moveable-sections (2) to translate through the end cover hole (401).

The variable-span wing for aircraft may also comprise one or more electronic stops (345), as shown in FIG. 29, where the one or more electronic stops (345) are designed to prevent over-extension or over-retraction of corresponding moveable sections (2).

A first general layout of the variable-span wing for aircraft is depicted in FIGS. 7-12. It comprises two driving mechanisms; one driving mechanism for each of the two moveable sections. Each driving mechanism comprises at least one motor (331) and at least one gear head (332), which may be pegged (333). The at least one gear head (332) is attached to the at least one motor (331) while the at least one motor (331) is attached to its corresponding moveable section (2) or to the track-mating part (320) that is attached to its corresponding movable section (2). The at least one motor (331) is located near the root of the moveable section (2) and the at least one motor (331) translates with the moveable section (2).

The first general layout of the variable-span wing also comprises at least one rack (341), which may be toothed or pegged (342) where the at least one rack (341) does not translate with the moveable section (2). The at least one gear head (332) meshes with the at least one rack (341). Rotation of the at least one gear head (332) against the at least one rack (341) causes the moveable section (2) to translate. The at least one rack (341) is located within the fixed section (1). For the set of sliding mechanisms each of the tracks (310) runs substantially spanwise across most of the fixed-section (1), as depicted in FIG. 6. At least one of the tracks (310) is located above the top moveable section (2) near the inner-upper surface of the fixed-section's skin (118) and at least one of the tracks (310) is located below the bottom moveable section (2) near the inner-lower surface of the fixed-section's skin (118).

The variable-span wing for aircraft can also comprise: a forward spar (116) where the at least one rack (341) is disposed on the forward spar (116), as seen in FIG. 7. For each driving mechanism there may be one motor (331) and one gear head (332). The gear head (332) may protrude forward near the leading edge (201) of the moveable section (2).

Alternatively, the variable span wing for aircraft may feature at least two racks (341) where one of the at least two racks (341) is disposed on the track (310) located above the top movable section near the inner-upper surface of the fixed-section skin (118). Similarly, one of the at least two racks (341) is disposed on the track (310) located below the bottom movable section near the inner-lower surface of the fixed-section skin (118), as depicted in FIG. 11.

A preferred arrangement for the set of sliding mechanisms involves four tracks; examples are depicted in FIGS. 12, 17, and 26. The four tracks consist of an upper forward track, an upper rear track, a lower forward track, and a lower rear track. The upper forward track, and the lower forward track are located near the leading-edge of the fixed section. The upper forward track is located above the lower forward track. The upper rear track and the lower rear track are located toward the trailing edge of the fixed-section. The upper rear track is located above the lower rear track. The upper forward and the upper rear track together guide translation of the top moveable section. The lower forward and the lower rear track together guide translation of the bottom moveable section. All four tracks are parallel to one-another and all four tracks run substantially spanwise across the fixed-section.

Each track-mating part (2) may comprise one attached frame (325) with: two or more vertically-oriented threaded holes, at least two threaded fasteners, and one of the two driving mechanisms (FIGS. 12 and 13). Each attached frame (325) is attached to one of the movable sections (2) near the root of the movable section (2). The driving mechanism is attached to the attached frame (325) both of which translate with the moveable section (2). The heads of the at least two threaded fasteners fit within the tracks (310) that guide translation of the track-mating part (320) and movable section (2). Each track-mating part (320) may also comprise rolling elements (323) that fit within each track (310) where the rolling elements (323) are disposed between the heads of the at least two threaded fasteners and the vertically-oriented threaded holes.

A second general layout of the variable span wing comprises one or more loop driving mechanisms, as seen in FIGS. 14, 15 and 16. Each loop driving mechanism comprises: two disc-like elements (334) and one loop-like element (343). The loop-like element (343) comprises an upper segment and a lower segment. The loop driving mechanism further comprises at least one driving motor (331). Each of the two disc-like elements (334) can rotate. At least one disc-like element (334) is driven by at least one driving motor (331). The loop-like element (343) is disposed about each of the two disc-like elements (334) forming the upper segment and the lower segment. Each moveable section (2) is attached, either directly or indirectly, to the loop-like element (343) of at least one of the one or more loop driving mechanisms. During rotation of the disc-like element (334) the loop-like element (343) moves around the periphery of the disc-like element (334) such that the upper segment of the loop-like element (343) moves in the opposite direction of the lower segment of the loop-like element (343). The loop-like element (343) moves the two moveable sections (2) in opposing directions into and out of the fixed-section (1).

An anti-binding version of the variable-span wing is depicted in FIGS. 17-23; it features track-mating parts (320) that comprise one or more frames (325), as seen in FIG. 17. The anti-binding version also comprises angle-sliders (322), as seen in FIG. 20. The angle-sliders comprise: two approximately perpendicular planes of material, at least one slot (324) in each perpendicular plane and at least one rolling element (323) partially passing-through the at least one slot (324). Each one of the frames (325) is attached to one of the movable sections (20 near the root of the moveable section (2). The rolling elements (323) in each track-mating part (320) fit within the tracks (310) that guide translation of the movable section (2).

Ideally, the track-mating parts will comprise rolling elements (323) where the rolling elements (323) are disposed in the tracks (310) and the axis of rotation of the rolling elements (323) is approximately parallel to the longitudinal direction (within +/−15 degrees). A slotted version of the variable-span wing is depicted in FIGS. 24-32, wherein for the set of sliding mechanisms the at least two tracks (310) are slot-like (316), as seen in FIG. 26. The at least two slot-like tracks (316) run parallel to the direction of moveable-section translation. The at least two slot-like tracks (316) each comprise: an inset slot (317) that does not pass all-the-way through its material, and a colinear slot (318) of lesser width that passes all-the-way through its material, as depicted in FIG. 27. Each of the at least two track-mating parts (320) comprise at least two separated rolling elements (323). The at least two separated rolling elements (323) are disposed in one of the slot-like tracks (316). Ports (326) pass through the colinear slots (318) and rolling elements (323).

An advantageous approach for variable-span wing assembly and disassembly is achieved when the right and left end covers (4) each further comprise an inner face (404) and an outer face (405), as seen in FIGS. 33 and 34. The variable-span wing may further comprise two end caps (319), which are one example of a cover-to-track attaching means. Each of the end caps (319) is attached to the inner face (404) of one of the end covers (4) and the end caps (319) are further attached to the tracks (310) at the tip edges of the tracks (310). Attachment of the tracks (310), end caps (319) and end covers (4) helps to properly align and position the tracks (310). The right and left end covers (4) each further comprise a flange (403) where the flange (403) protrudes inwardly from the inner face (404) of the end cover (4) near the periphery of the end cover (4) (FIG. 35A). The flange (403) is shaped like the tip-airfoil of the fixed-section (1). The flange (403) fits into the corresponding tip-opening (126) of the fixed-section (1) where it may help to support the fixed-section's skin (118). The outer periphery of the right end cover (4) is larger than the outer periphery of the flange (403) so that the inner face (404) of the right end cover (4) interfaces with the fixed section (1), as seen in FIG. 34. Similarly, the outer periphery of the left end cover (4) is larger than the outer periphery of the flange (403) so that the inner face (404) of the left end cover (4) interfaces with the fixed section (1). This advantageous approach is compatible with both of the two general layouts as described and shown. FIGS. 33-35B depict the advantageous approach for the second general layout with a loop-driving mechanism.

The right end cover (4) attaches to the right tip-end of at least one of the tracks (310) with the cover-to-track attaching means. Similarly, the left end cover (4) attaches to the left tip-end of at least one of the tracks (310) with the cover-to-track attaching means. This design allows an assembly that includes the sliding mechanism and the two movable sections (2) to fit securely within the fixed section (1) between the two end covers (4) and it allows said assembly to conveniently slide into and out-of the fixed section (1) through one of the tip openings (126) when at least one of the end covers (4) is removed.

The variable-span wing was invented with a particular aircraft in mind, which is the aircraft depicted in FIG. 1. This aircraft comprises the variable-span wing as well as fins (6), a propulsion system (8), and at least one set of two elevons (5). The aircraft can stand upright on its fins (6) for takeoff and landing, as depicted in FIG. 37. After takeoff it can hover and transition to a conventional orientation by pitching-forward. During conventional flight the aircraft can pitch upwards to re-enter its hovering orientation prior to landing. The propulsion system (8) comprises at least two sets of a motor (802) and a propeller (803) where the at least two sets of the motor (802) and the propeller (803) are located forward of the leading-edge (101) of the fixed-section (1), as seen in FIG. 3A. The at least two sets of the motor (802) and the propeller (803) are symmetrically disposed about the aircraft's plane-of-symmetry (114). At least one set of the motor (802) and propeller (803) lies on the left side of the aircraft and at least one set of the motor (802) and propeller (803) lies on the right side of the aircraft. The at least one set of the motor (802) and the propeller (803) lying on the right side of the aircraft rotate opposite to the at least one set of the motor (802) and the propeller (803) lying on the left side of the aircraft. The two elevons (5) in the at least one set of two elevons (5) are symmetrically disposed about the aircraft's plane of symmetry (114), as seen in FIG. 3A. The two elevons are located near the trailing-edge (102) of the fixed-section (1) and are at least partially immersed in propulsive slipstreams (804). The elevons (5) deflect symmetrically for pitch-control (FIG. 38), and they deflect differentially for roll control (FIG. 39).

The aircraft comprises at least one pair of fins (6), where each fin (6) comprises a fin tip (606), as seen in FIG. 3A and FIG. 37. The at least one pair of fins (6) are symmetrically disposed about the aircraft's plane-of-symmetry (114).

### BRIEF DESCRIPTION OF THE SEVERAL VIEWS OF THE DRAWING

FIG. 1 depicts an example aircraft utilizing the variable-span wing with fully-extended moveable sections in a conventional flight orientation;

FIG. 2 depicts the variable-span wing with moveable sections fully-retracted;

FIG. 3A is a planform view of the variable-span wing with moveable sections partially extended;

FIG. 3B shows example airfoils for the fixed and moveable sections;

FIG. 4 depicts an example interface between fixed and moveable wing sections;

FIG. 5 shows an interface with its end cover removed to expose an example actuation system (Embodiment A1);

FIG. 6 shows an example actuation system with the fixed-section skin invisible and moveable-sections partially-extended; (Embodiment A1);

FIG. 7 is a side-view depiction of the example actuation system of FIGS. 5 and 6 with the end covers removed (Embodiment A1);

FIG. 8 is a side view with the end covers removed to expose an embodiment with trailing-edge stabilizers in the form of passively-rotating spring-gear mechanisms (Embodiment A2);

FIG. 9 shows the trailing-edge stabilizer of FIG. 8 (Embodiment A2) as well as a pegged-gear and a pegged-rack;

FIG. 10 illustrates an embodiment of the moveable section actuation system that does not include a trailing-edge stabilizer (Embodiment A3);

FIG. 11 depicts a preferred gear-rack embodiment of the actuation system (Embodiment A4);

FIG. 12 shows a side-view of a preferred arrangement for the moveable section actuation system (Embodiment A5);

FIG. 13 is a perspective view of the A5 embodiment of the moveable section actuation system;

FIG. 14 is a sideview of a loop-driving mechanism for the moveable section actuation system with end covers removed (Embodiment B);

FIG. 15 depicts an example loop-driving mechanism with fixed-section skin removed to show toothed pulleys and a toothed belt with one motor to drive translation of both moveable sections (Embodiment B);

FIG. 16 is a close-up view of the key elements comprising an example loop-driving mechanism (Embodiment B);

FIG. 17 has the fixed-section skin removed to show and anti-binding version of the variable-span wing (Embodiment C);

FIG. 18 shows the anti-binding version with fixed and moveable section skin removed (Embodiment C);

FIG. 19 is a close-up view of a set of track-mating parts for the anti-binding version (Embodiment C);

FIG. 20 depicts the angle-sliders of the anti-binding version (Embodiment C);

FIG. 21 is a side-view of the anti-binding version with end-covers removed (Embodiment C);

FIG. 22 is a close-up view of the motor, pulley and belt that drive the moveable sections for the anti-binding version (Embodiment C);

FIG. 23 shows the rear track used for the anti-binding version (Embodiment C);

FIG. 24 depicts a slotted version of the variable-sweep wing with fixed-section skin removed (Embodiment D).

FIG. 25 shows the slotted version with its fixed-section skin and the stringers removed (Embodiment D);

FIG. 26 is a close-up of the slotted version of the actuation system (Embodiment D);

FIG. 27 is an exploded view of an assembly of parts for the slotted version (Embodiment D);

FIG. 28 is an assembled perspective view of the slotted version (Embodiment D);

FIG. 29 is a subassembly of a motor, spacers, and electronic stops for the slotted version of the variable-span wing (Embodiment D);

FIG. 30 is a calibration bolt used to precisely adjust moveable section stopping locations;

FIG. 31 is a side-view of the slotted version with end covers removed (Embodiment D);

FIG. 32 illustrates an end cover attached to stringers using threaded fasteners (Embodiment D);

FIG. 33 depicts a version of variable-span wing, with fixed-section skin removed, that is compatible with the advantageous approach to assembly and disassembly (Embodiment E);

FIG. 34 shows an improved end cover design enabling the advantageous approach to assembly and disassembly (Embodiment E);

FIG. 35A depicts a track-end cap-end cover design that allows an inner assembly of parts to be slid into and out of the fixed section for ease of installation and maintenance (Embodiment E);

FIG. 35B illustrates an example loop driving mechanism with a motor and gear set that can be slid into and out of the fixed-section (Embodiment E);

FIG. 36A shows an example orientation for a track and rolling elements as a cross-section side-view, where the rolling elements are cylindrically-shaped;

FIG. 36B shows an example orientation for a track and rolling element as a cross-section side-view, where the rolling element is a linear bearing that utilizes ball bearings;

FIG. 37 depicts an example aircraft tail-sitting (standing upright) as it would prior to takeoff and after landing;

FIG. 38 illustrates a pitch-input for a particular aircraft using symmetric elevon deflection;

FIG. 39 illustrates a roll-input for the particular aircraft using differential elevon deflection;

FIG. 40 depicts a tricycle embodiment of the particular aircraft for optionally conventional takeoff/landing;

FIG. 41 is a top-view of a variable-span wing used on a hybrid jump-type VTOL multi-rotor;

FIG. 42 is a front view of two variable span wings applied to a biplane;

FIG. 43 is a top-view of the variable-span wing applied to a highly-swept flying wing aircraft;

FIG. 44 is a front-view of the variable span wing applied to a conventional airplane with significant dihedral;

### DETAILED DESCRIPTION OF THE INVENTION

### Definitions

The definitions provided herein are mostly intended for convenience and general clarification. Terms used throughout this patent should not be strictly-limited by the definitions provided herein.

“Aerodynamic center” refers to the chordwise point on an airfoil about which aerodynamically-induced moment is approximately independent of angle of attack (111, 211) in the pre-stall angle of attack range. The aerodynamic center is measured aftward from the leading edge of the airfoil and moment is expressed per unit span. A full three-dimensional wing has a similarly-defined aerodynamic center, which falls on a laterally-oriented line at a particular longitudinal position. The longitudinal position is measured aft from the leading edge of the wing's root airfoil.

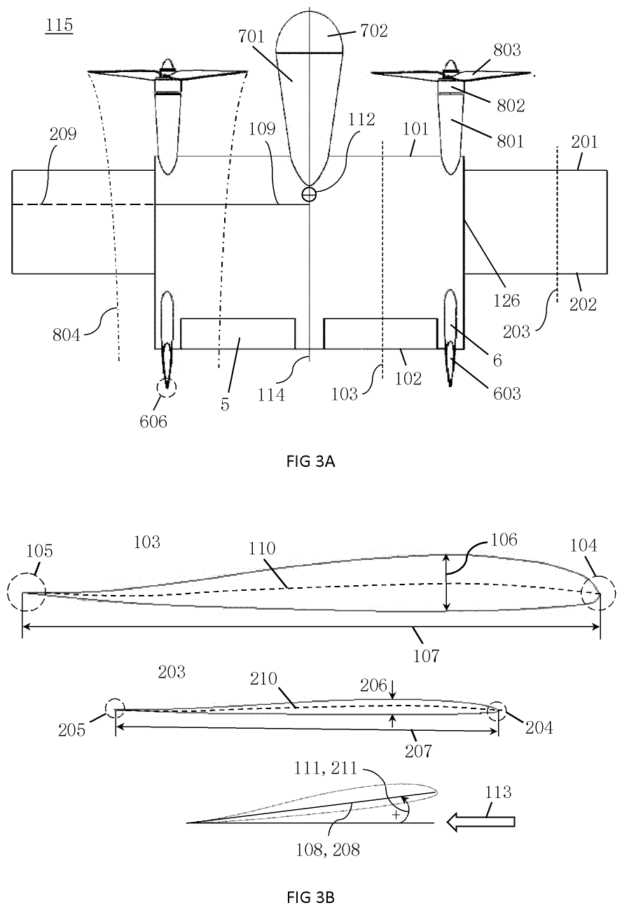

“Angle of attack” (111, 211) for an airfoil refers to the angle between the freestream velocity vector (113) and the chord-line (108, 208 see FIG. 3B). For a wing or an aircraft it is the angle between the freestream velocity vector and a reference line.

“Angle of incidence” refers to an angle that is positive as-measured from a reference line (usually the longitudinal axis of a fuselage) to the chord-line of an airfoil.

“Cambered” airfoils are not “symmetric”. “Cambered” typically refers to an airfoil whose camber-line (110, 210) does not have an inflection point, and whose camber-line curves downward near the trailing-edge.

“Chordwise” refers to a direction parallel to the chord-line (108, 208) of an airfoil.

“Cruise” refers to straight-and-level flight at a speed corresponding to maximum aerodynamic efficiency.

“Dihedral” is also commonly-defined in aircraft-related textbooks. It refers to how upwardly bent a wing is with respect to the horizontal plane. Dihedral is usually expressed as an angle in degrees (124, FIG. 40).

“Disc-like element” refers to a disc-shaped component about which a loop-like element is disposed. For example, a disc-like element could be a: pulley, sprocket, toothed pulley, gear, drum, wheel, or another substantially equivalent part.

“Driving element” refers to a thing or to a collection of closely-associated things that together provide a pushing or a pulling force to drive moveable section translation, which includes, but is not limited to: electric motors, hydraulic actuators, spring-loaded devices, human pilots, etc.

“Empennage” is the tail assembly of an aircraft, which typically includes at least one: horizontal stabilizer, vertical stabilizer, elevator, and rudder.

“Engaging element” refers to a thing that interacts with driving elements to help control moveable section translation.

“Fixed-wing” is a term that distinguishes a wing from rotors, propellers, and other spinning aerodynamic surfaces that are occasionally called “rotating wings” or “rotary wings”. The term “fixed-wing” excludes flapping-wings and variable-sweep wings (aka “swing-wings”), as well as the variable-span wing presented herein.

“Freestream velocity” is has a direction and magnitude equal to that of undisturbed oncoming flow far upstream from a body as viewed from the body-fixed frame of reference.

“Hybrid” refers to aircraft that combine distinct features of conventional aircraft in a less-conventional way; the V-22 Osprey combines elements from airplanes and helicopters.

“Inboard” generally refers to the “inner” region of an aircraft, near the root of its wing.

“Lateral” refers to the “sideways” direction of an aircraft. It is perpendicular to both the longitudinal and vertical directions and is similar to the “spanwise” direction for a wing.

“Lift-generating wing-surface” underscores that the fixed-section can generate lift and that it has airfoils (as do all wings). This does not exclude fixed-sections that include a fuselage, or fixed-section that are of a blended wing body type.

“Longitudinal” generally refers to the “long” dimension of an object; herein it is used in accordance with standard aircraft-related terminology. “Longitudinal” refers to the nose-to-tail aircraft direction, which is parallel to both the horizontal plane and the plane of symmetry.

“Loop-like element” refers to a part that forms a closed loop that is disposed about disc-like elements. A loop-like element could be a: string, chain, rope, cable, belt, toothed belt, or a substantially equivalent part.

“Moment” is interpreted based on context. It may refer to the moment (or torque) exerted on an airfoil, wing, or aircraft, by a flow of air. Or it may refer to moments about specific axes, such as pitching, rolling, or yawing moments.

“Near” is quantitatively defined to mean that the distance between the closest points of the compared elements is no greater than 35% of the root chord-length of the fixed-section (the largest such chord-length if there is more than one fixed section).

“Neutral point” is analogous to the aerodynamic center for airfoils and wings, but it refers to a whole aircraft.

“Outboard” generally refers to the “outer” region of an aircraft, near its wingtips.

“Plane of symmetry” is commonly-used and understood in aircraft textbooks; it applies even when there are minor deviations between the left and right halves of an aircraft (for example, if one side has a protruding pitot tube, but not the other). Note that for a monoplane, traditional biplanes, and tandem-wings the plane of symmetry for a wing and its aircraft are necessarily parallel and coincident; they are the same plane. Therefore, we herein use the term “plane of symmetry” without specific reference to a wing or aircraft. Bizarre designs could be conceived-of for which multiple non-tandem wings are utilized, or for which the aircraft has very significant asymmetry. For such bizarre cases the “plane of symmetry” should be interpreted based on context. For an aircraft it would be a vertical plane oriented parallel to the primary flight direction and coincident with the center of mass of the aircraft.

“Propeller” encompasses fixed and variable-pitch propellers, as well as near-synonymous terms including “fan”, but does not refer to rotating systems with blades that pitch cyclically, as with a swashplate in helicopters and other rotary-wing aircraft.

“Reflexed” airfoils have a camber-line (110, 210) with an inflection point (FIG. 3B). “Reflexed” airfoils are sometimes described as having an “S-shaped” camber-line; the S-shape is normally very subtle. The trailing edge of a reflexed airfoil typically points slightly upward.

“Rolling element” refers to a part or an assembly of parts that include at least one rotating component designed to reduce resistive force that opposes relative motion between one or more tracks and track-mating parts. Examples include: a roller, wheel, or any applicable bearing: tapered, untampered, roller-type, ball bearing type, ring-shaped, or any-shaped. Linear-motion bearings appear to slide but typically include rotating components (e.g. ball bearings) and-so constitute “rolling elements” under the definition provided herein.

“Root” is used to refer to the “beginning” of a wing or section (fixed or moveable). The root of a normal wing lies on its plane of symmetry. Similarly, a fixed-section's root will typically lie on an aircraft's plane-of-symmetry. The “root” of a moveable section is its inner-most spanwise part when the moveable section is fully extended.

“Root airfoil” for a wing or a fixed section refers to the airfoil at the plane-of-symmetry. When an obstruction is present (e.g. a fuselage or mount) “root airfoil” refers to the airfoil one would get at the plane-of-symmetry if unobstructed wing airfoils were extrapolated to the plane-of-symmetry based on their spanwise distribution of: shape, chord-length, thickness, twist, sweep, dihedral, and other relevant parameters. For moveable sections the “root airfoil” refers to the inner-most airfoil when a moveable section is fully extended.

“Sharp” is commonly-understood. For rounded airfoil edges sharpness can be quantified as the minimum radius of curvature expressed as a percentage of airfoil chord-length, where a smaller radius denotes a sharper edge. The sharpness of squared-off edges can be quantified as half the distance between the airfoil upper and lower surfaces at their aft-most chord-wise position expressed as a percentage of airfoil chord-length.

“Sliding mechanisms” refers to tracks and track-mating parts; “sliding mechanisms” may include rolling elements that roll over the tracks to reduce resistance from relative motion.

“Slipstream” refers to a flow or air generated by a rotating propeller; its simplified bounded theoretical shape resembles a circular cylinder whose cross section decreases non-linearly with distance downstream of the propeller (804, FIG. 3A).

“Spanwise” refers to a direction perpendicular to the chordwise direction for an airfoil or wing. Imagining a sketch of an airfoil the spanwise direction would be “coming out of the page”.

“Static margin” is defined as the distance between the center of mass and the neutral point of an aircraft, expressed as a percentage of the wing's mean aerodynamic chord-length.

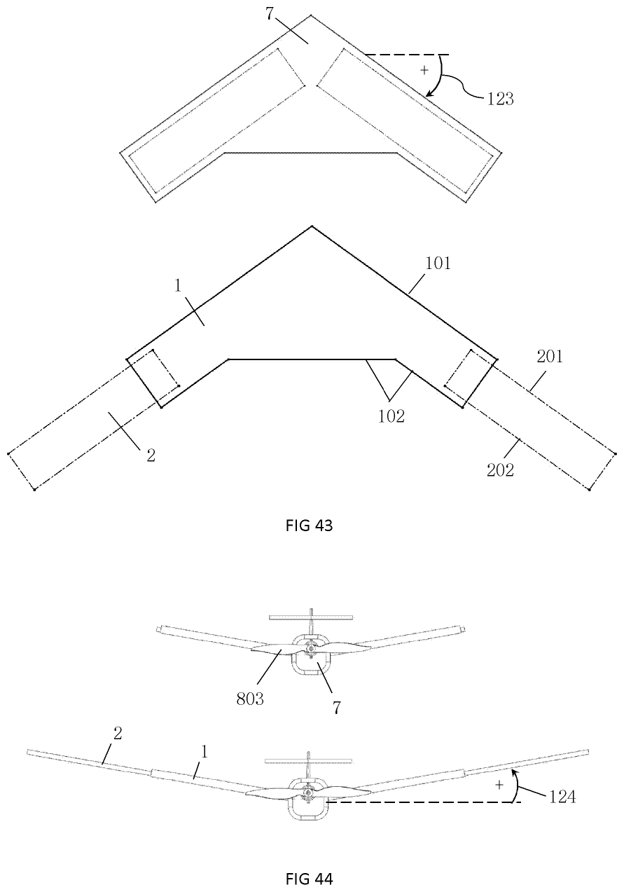

“Sweep” is common aircraft-related terminology. often expressed as an angle measured between the lateral axis of an aircraft and the leading-edge of its wing (123, FIG. 43).

“Swirl” refers to the circumferential velocity component within a slipstream that arises due to propeller rotation and which can cause helical slipstream flow.

“Symmetric” airfoils have a straight camber-line (110, 210) such that the camber-line and chord-line (108, 208) are coincident and the upper and lower airfoil surfaces are reflections of each other about the chord-line.

“Tail-sitter” refers to a kind of aircraft that can takeoff from a position in which the aircraft is standing in an upright orientation and where the aircraft can then tilt from a predominantly vertical to a predominantly horizontal orientation for forward flight.

“Tapered” refers to wings whose airfoil chord-length varies with spanwise position.

“Tip” is commonly understood. When referring to wings and wing sections the terms “root” and “tip” are opposites. For a fixed section it refers to the outer-most tips of the fixed section and for a moveable section it refers to the outer-most tip of the moveable section.

“Tip-opening” refers to an opening (or hole) at a tip of a fixed-section that is sufficiently large to allow a moveable section to pass through it; an end cover may be installed over and/or into the tip opening.

“Track” refers to a path along which something moves.

“Track-mating part” refers to a part that is constrained to move along a track.

“Twist” (see “washout”).

VTOL=vertical takeoff and landing.

“Washout” refers to “structural washout”, which is a characteristic of aircraft wings whereby the wing is slightly twisted such that the angle of incidence is greater toward the wing root and decreases along the span, becoming lower toward the wing tips.

LIST OF SYMBOLS

1 - fixed section;
101 - leading-edge (of fixed section);
102 - trailing-edge (of fixed section);
103 -airfoil;
104 - leading-edge (of airfoil);
105 - trailing-edge (of airfoil);
106 - thickness;
107 - chord-length;
108 - chord-line;
109 - quarter-chord line;
110 - camber-line;
111 - angle of attack;
112 - center of mass;
113 - freestream velocity;
114 - plane of symmetry;
115 - horizontal plane;
116 - forward spar;
117 - rear spar;
118 - skin;
119 - stringer;
120 - cut-out;
121 - installation holes;
122 - special stringer;
123 - sweep;
124 - dihedral;
126 - tip opening;
2 - moveable section;
201 - leading-edge (of moveable section);
202 - trailing-edge (of moveable section);
203 -airfoil;
204 - leading-edge (of airfoil);
205 - trailing-edge (of airfoil);
206 - thickness;
207 - chord-length;
208 - chord-line;
209 - quarter-chord line;
210 - camber-line;
211 - angle of attack;
212 - rib;
213 - spar;
3 - actuation system;
310 - track;
311 - T-slot;
312 - angle-channel;
313 - upper triangle;
314 - central track;
315 - lower triangle;
316 - slot-like track;
317 - inset slot;
318 - colinear slot;
319 - end cap;
320 - track-mating part
321 - T-slider;
322 - angle-slider;
323 - rolling element (e.g. bearing);
324 - slots;
325 - frame;
326 - ports;
327 - sliding plate;
328 - bearing plate;
329 - frame holes;
330 - driving elements;
331 - motor;
332 - gear head;
333 - pegged gear head;
334 - disc-like element;
336 - spacer;
337 - modified spacer;
338 - gear set;
339 - motor installation bracket;
340 - engaging elements;
341 - rack;
342 - pegged rack;
343 - loop-like element;
344 - loop-to-section attaching means;
345 - electronic stops;
346 - trigger;
347 - calibration bolt;
350 -trailing-edge stabilizer;
4 - end cover;
401 - end cover hole;
402 - threaded fastener;
403 - flange;
404 - inner face;
405 - outer face;
5 - elevon;
6 - fin;
603 - airfoil
606 - fin tip
7 - fuselage;
701 - body;
702 - window;
703 - battery;
704 - electronics assembly;
8 - propulsion system;
801 - nacelle;
802 - propulsive motor;
803 - propeller
804 - slipstream
9 - landing gear;
901 - nose wheel;
902 - rear wheel;

### Variable-Span Wing

The variable-span wing can be applied to aircraft having at least one wing. The variable-span wing comprises one or more fixed sections (1), at least two moveable sections (2), and an actuation system (3) for the moveable sections. The moveable section actuation system (3) comprises driving elements (330) to push-and-pull moveable sections (2) causing them to translate in a predominantly lateral direction into and out of fixed sections (1). As moveable sections (2) translate outward wingspan, wing planform area, and wing aspect ratio all increase significantly.

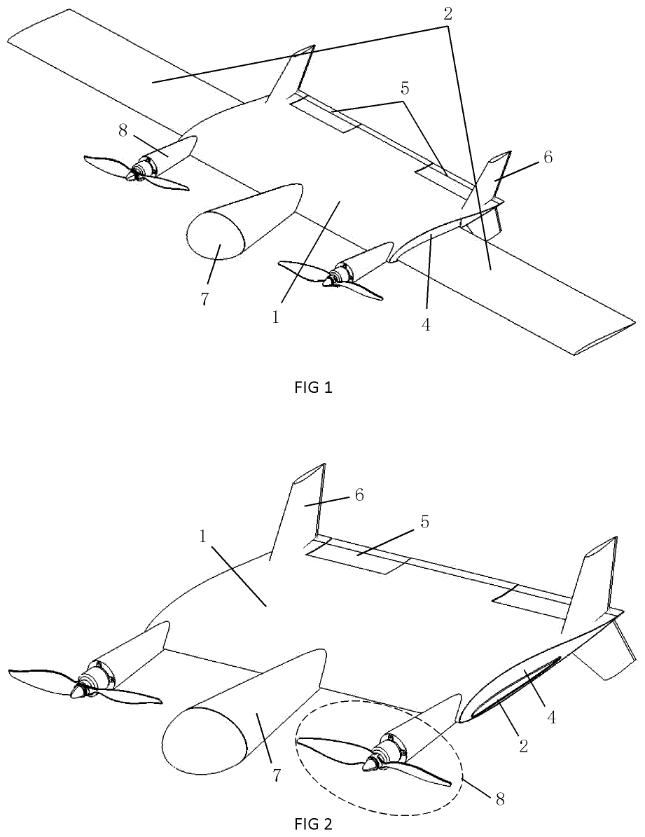

“Cruise” refers to straight-and-level flight at a speed corresponding to maximum aerodynamic efficiency. Low-speed cruise is realized when moveable sections (2) (FIG. 1) are fully extended. High speed cruise is realized when moveable sections (2) are fully retracted (FIG. 2). Moveable sections (2) may translate continuously to enable a wide range of efficient flight speeds to be realized.

Fixed-sections (1) are symmetrically disposed about the aircraft's plane-of-symmetry (114). Fixed sections (1) are designed to maximize internal space to better-accommodate moveable sections (2). They (1) have a structural design with load-bearing skin (118) and a mostly hollow interior (monocoque). Fixed-sections (1) are strengthened by two or more spanwise-running spars (116, 117), as seen in FIG. 5. The forward spar (116) is nearer to the leading edge (101) of the fixed section (1) and the rear spar (117) is nearer to the trailing edge (102) of the fixed section (1). To minimize weight the spars (116, 117) can have thin substantially rectangular cross-sections with holes or cut-outs (120) and be made using a lightweight material, like aluminum or fiberglass. Excessive deformation can diminish aerodynamic performance. When needed, spanwise-running stringers (119) can be added to the inner surface of the fixed-section's skin (118) to increase stiffness (119, FIG. 24).

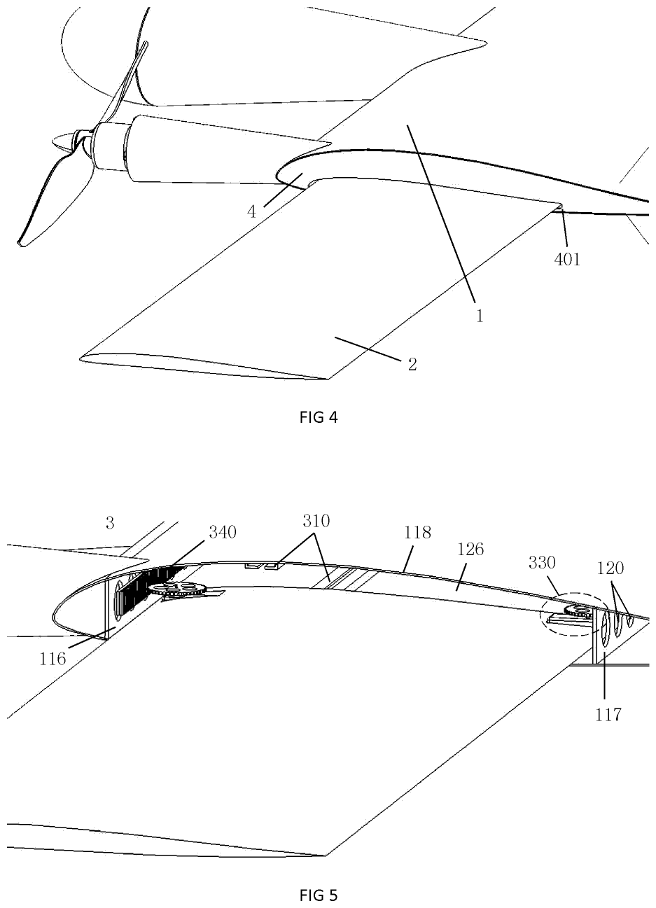

The fixed-section (1) is further supported by end covers (4). Together, the spars (116, 117) and end covers (4) create a structural “wing-box” that is strong and lightweight. End covers (4) are placed at the tips of the fixed section (4), as seen in FIG. 4; they prevent foreign objects from entering the fixed section (1). End-covers (4) also reduce aerodynamic interference near the interface between fixed (1) and moveable (2) sections and reduce undesired airflow into the fixed section (1). End covers (4) have end cover holes (401) cut into them to allow in-and-out translation of the moveable sections (2) and to help support moveable sections (2) during partial-extension. For simpler moveable section (2) designs end cover holes (4) should be airfoil-shaped.

The fixed section (1) is comprised of an infinite number of airfoils (103) that feature a round leading edge (104) and a sharper trailing edge (105), as seen in FIG. 3B. Fixed sections (1) will typically use symmetric or reflexed airfoils when applied to flying-wing designs, which is generally necessary for passive longitudinal stability. Standard cambered airfoils may be used with flying wing designs, in which case the wing might require a lot of sweep (123) and twist to provide longitudinal stability.

Moveable section airfoils (203) also feature rounded leading edges (201), sharper trailing edges (202), and they will typically utilize either symmetric or reflexed airfoils. Each moveable section (2) in a pair is designed to be a mirror image of the other about the plane of symmetry (114), excepting vertical offset when overlap is used.

Various parameters must be balanced to maximize overall system performance while satisfying geometric constraints imposed by the need to contain moveable sections (2) within a fixed section (1). To contain moveable-sections (2) within a fixed-section (1) it is necessary to make fixed-section airfoils (103) relatively thick, and moveable section airfoils (203) relatively thin, and/or to make chord-lengths of fixed-section airfoils (107) relatively long and those of moveable sections (207) relatively short (FIG. 3). A reasonable balance between airfoil thicknesses (106, 206) and chord-lengths (107, 207) for the fixed (1) and moveable (2) sections produces optimal results. If a fixed section (1) is made too thick then its lift-to-drag ratio will become unacceptable. If moveable-section airfoils (203) are made too thin then the moveable sections (2) will be too weak, prone to stall, and their efficient angle of attack (211) range will be too narrow.

Too maximize the efficacy of the variable-span wing it is desirable for moveable sections (2) to be vertically offset from one-another and to overlap when fully retracted, in which case geometric constraints become especially limiting. For this case, fixed-section airfoils (103) should have a maximum thickness (106) that is greater than 6% of chord-length (107) and greater than the maximum thickness (206) of the moveable-section airfoils (203). The mean geometric chord-length (207) of moveable sections (2) should be between 30% and 70% of the mean geometric chord-length (107) of corresponding fixed sections (1).

If moveable sections (2) are straight then the aircraft's stall may be severe (tip-stall). The angle of incidence of the moveable sections (2) can be lower than that of the fixed-section (1) such that the fixed-section stalls first (no tip stall). Alternatively, moveable sections can be twisted (washout) to prevent a tip-stall, but there must be adequate space within the fixed section to house the twisted moveable sections (2) and end cover holes (401) may have to be enlarged to allow twisted sections (2) to pass through them.

Another option is to design a track (310) that is slightly twisted such that the moveable section's (2) angle of incidence decreases as the sections extend further away from stall-delaying propulsive slipstreams (804). Alternatively, propulsive motors (802) can be placed near the tips of the moveable sections (2), and move with the moveable sections, in order to maintain tip vortex opposition and reduce the severity of tip-stalls, but that may create other issues associated with the wing structure, electrical wiring, etc.

For moveable sections (2) that overlap their geometry should be restricted to remain within the following reasonable angular magnitude limits: dihedral ≤3 deg (124), washout ≤5 deg, leading-edge sweep ≤6 deg (123). For examples of variable-span wings with non-overlapping moveable sections (2) see FIGS. 43 and 44.

The actuation system (3) comprises tracks (310) and track-mating parts (320). Track-mating parts (320) are constrained to move along tracks (320). The actuation system (3) should be designed such that left and right moveable sections (2) always have equal-and-opposite translational positions. Geometric symmetry ensures reasonably symmetric aerodynamic loading to prevent undesired rolling, yawing, or pitching moments from being produced.

Tracks (310) can be placed on moveable (2) or on fixed sections (1). Track-mating parts (320) can correspondingly be placed on fixed (1) or on moveable sections (2). It is preferable for the tracks (310) to be located on a fixed-section (1) and wholly within a fixed-section (1) to avoid spoiling outside airflow. Similarly, it is preferable for track-mating parts (320) to be located near the roots of moveable sections (2), to translate with moveable sections (2), and to be subject to translational restriction such that track-mating parts (320) always remain wholly within fixed sections (1). Aerodynamic forces tend to bend moveable sections upward, so track-mating parts (320) must be designed to mate with the tracks (310) in such a way as to support applied bending moments and other expected loads without binding.

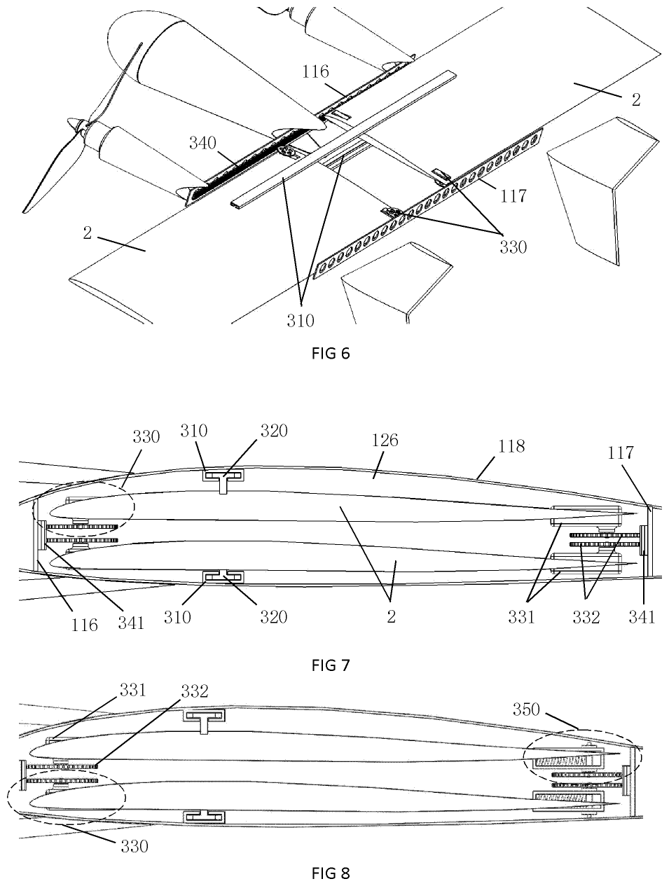

It is sensible for the adaptive wing system to utilize either two or four tracks (310). When using two tracks (310) one can be placed near the inner upper-surface of the fixed-section (1), and one near the inner lower-surface of the fixed-section (1), as seen in FIG. 7. This provides one track (310) per moveable section (320). When utilizing four tracks (310) one can be placed on the inner-upper-forward surface of the fixed section (1), one on the inner-upper-rearward surface, one on the inner-lower-forward surface and one on the inner-lower-rearward surface to provide two tracks per moveable section (2).

### Aerodynamic Considerations

This section is intended to provide basic insight into some general aerodynamic considerations as they relate to the design of the variable-span wing. It is intended to be neither detailed nor thorough. The simplest case is presented and discussed.

In balanced-level flight lift (L) is equal to an aircraft's weight (W). As moveable sections (2) extend outward wing planform area (S) increases which, if all else is held constant, causes wing loading (W/S) to decrease.

$$\frac{W}{S} = \frac{1}{2} ρ {V}^{2} {C}_{L}$$

Aircraft weight (W) and air density (ρ) are constant, so to maintain balanced level flight the lift coefficient (C_{L}) of the wing, and/or the velocity of the aircraft (V) must decrease. Lift coefficient (C_{L}) is a function of angle of attack (α); maximum aerodynamic efficiency (L/D) occurs at a particular angle of attack (α). Therefore, it is generally preferable to decrease velocity (V). Some velocity (V) decrease occurs naturally without control input because drag (D) increases with wing area (S).

D=½ρV²SC_{D}

Further deceleration is achieved by decreasing throttle, which a pilot can do manually, or an onboard flight controller can do automatically. Outward extension of moveable sections corresponds to slower flight, lower thrust, and less power consumed.

Longitudinal balance, stability, and control must be ensured at every moveable section (2) position. If the aerodynamic center of a wing drifts too far forward then longitudinal stability will be lost. Similarly, if the aerodynamic center of a wing drifts too far aftward then an aircraft will become excessively “nose-heavy” such that it is unable pitch-up.

The aerodynamic center of an airfoil is typically near its quarter-chord point (+/−5% of chord). Moveable sections (2) can be designed with constant chord-lengths (207) and no sweep such that the aerodynamic center of each airfoil falls on a straight laterally-running line (FIG. 3A, 209). In this case the aerodynamic center of each moveable section (2) becomes independent of translational position. If, in addition, the aerodynamic center of each moveable section (2) is placed at the same longitudinal position as the aerodynamic center of the fixed-section then the aerodynamic center of the entire wing becomes independent of moveable section translational position, which ensures that longitudinal stability is always maintained. To make things as simple as possible the fixed section can be of constant chord-length (107) and without sweep. In that case, the quarter-chord line of the moveable sections (209) is simply aligned with the quarter chord line of the fixed section (109), as depicted in FIG. 3A.

As the moveable sections extend outward the span of the wing (b) increases. If the magnitude of the moment coefficient for moveable section airfoils (Cₘ) is high then the moment being exerted on the wing (M) will change significantly during translation—all else held constant.

M=½ρV²C²bCₘ

As a result of the change in moment, an aircraft would have a tendency to pitch as moveable sections translate. The tendency to pitch could be counteracted via a pitch control input, but control surface deflection angles should remain near zero during cruise. The tendency to pitch could be counteracted by changes in angle of attack (α), which would cause the moment coefficient to change (Cₘ). As stated previously, it is preferable for flight velocity (V) to decrease as moveable sections extend outward so the system should be designed such that the decrease in aircraft velocity (V) counteracts the increase in span (b) and aerodynamic moment (M) remains constant. This can be achieved through proper airfoil design given other relevant aircraft parameters.

The situation becomes more complicated if the aircraft has an empennage, canard, or if moment from the fixed-section changes significantly with velocity. In that case, the effects of these aircraft components on pitching moment must also be considered when designing moveable section airfoils. The net effect of moveable section translation on pitching moment should be near-zero at each cruise speed corresponding to each translational position. The simplest way to ensure this is to select or design airfoils whose moment coefficient is near-zero in the pre-stall angle of attack range (e.g. symmetric or slightly reflexed airfoils).

A design program for variable-span wings was written based on simple theories (e.g. thin airfoil theory, finite wing theory) and reasonable assumptions. A variable-span wing was designed for a tail-sitter aircraft, for which a large span cannot be used during takeoff and landing due to gust sensitivity. The variable-span wing allowed the aircraft to have a short wing during takeoff, landing, and hovering, and to have a long wing during cruise. Wing span increased ^{˜}160% between the fully retracted and fully extended conditions, wing planform area increased ^{˜}100%, cruise speed decreased ^{˜}35%, and induced drag at cruise decreased ^{˜}60%.

### Design Embodiments

The variable-span wing can be designed many different ways. It will generally comprise one fixed-section (1) with spars (116, 117) and load-bearing skin (118), two moveable-sections (2), end covers (4) with end cover holes (401), and an actuation system (3) for the moveable sections (2). The actuation system (3) may comprise tracks (310), track-mating parts (320), driving elements (330) and engaging elements (340). Driving elements (330) interact with engaging elements (340) to push-and-pull moveable sections (2) in-and-out of the fixed-section (1), subject to motion constraints provided by the track (310) and track-mating parts (320).

Many different mechanisms may be used to help achieve lateral translation of moveable sections (2), including: gears, pulleys, racks, chains, ropes, belts, slots, pegs, etc. The moveable section actuation system (3) requires at least one driving element (330) to force moveable sections (2) to translate. A driving element (330) could be many things. One example of a driving element (330) is a person manipulating manual controls through a series of ropes, pulleys, etc. Another example could be a computer-driven elecrtohydraulic actuator. Of the many potential driving elements (330) the most-preferred is a motor (331) that is electric. Motors (331) may be fastened to fixed sections (1), moveable sections (2), or virtually any part of an aircraft.

### Embodiment A1

The A set of embodiments is depicted in FIGS. 5-13. For Embodiment A1 the track (310) is of a T-slot (311) type and the track-mating part (320) is of a T-slider (321) type. The driving elements (330) are motors (331) and gear heads (332); the engaging elements (340) are racks (341) located on the forward (116) and rear (117) spars. The forward spar (116) is nearer to the leading-edge (101) and the rear spar (117) is nearer to the trailing-edge (102) of the fixed-section (1). The actuation system (3) utilizes two motors (331) per moveable-section (2), which are each embedded near the roots of the moveable-sections (2). The gear heads (332) are disposed on the motors (331) and stick-out past the leading (201) and trailing (202) edges of the moveable-sections (2).

Gear heads (332) engage the racks (341), which are rigidly attached to spars (116, 117) located inside of the fixed-section (1) such that gear head (332) rotation causes translation of moveable sections (2). Embodiment A1 features vertically-offset moveable sections (2) that overlap when retracted. The upper moveable-section has gear heads (332) located below its lower surface and the lower moveable section has gear heads (332) located above its upper surface, which allows both moveable sections (2) to use the same racks (341).

Embodiment A1 also has tracks (310) and track-mating parts (320), which are needed to guide lateral translation of the moveable-sections (2). The tracks (310) are attached to the fixed-section (1) and run almost its entire span. One track (310) is attached to the upper-inner surface of the fixed-section's skin (118), and the other is attached to the lower-inner surface of the fixed-section's skin (118). Each track (310) has a T-slot (311) to accommodate a T-slider (321).

The upper moveable section's track-mating part (320) is located above its upper surface. The lower moveable section's track-mating part (320) is located below its lower-surface. The track-mating parts (320) are T-sliders (321, FIG. 7), which are attached to each moveable-section (2) near its root. The T-sliders (321) are quite short relative to the span of the moveable sections (2), but their length is sufficient to support expected loads.

Embodiment A1 has only one track (310) per moveable section (FIGS. 5-7). Each track (320) is positioned along the quarter-chord line (209) of each moveable section (2) to minimize moveable section twisting. The aircraft should be flown such that the moveable-sections (2) never stall and torque loads (loads that cause a wing section to “twist”) are kept sufficiently small to avoid breaking tracks (310) and track-mating parts (320).

### Embodiment A2

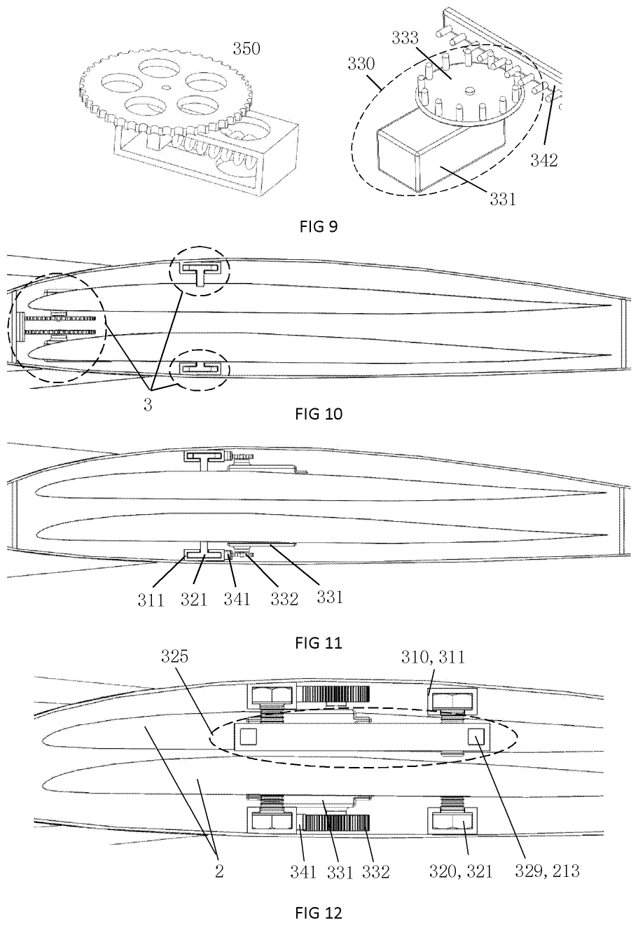

Embodiment A1 utilized two motors (331) per moveable section (2), for a total of four motors. Using four motors is not strictly necessary and it complicates motor synchronization within and between the moveable sections (2). Embodiment A2 is depicted in FIG. 8. Embodiment A2 utilizes just one motor (331) per moveable section. It is best to position each motor (331) and gear head (332) near the leading-edges (201) of the moveable sections to minimize the distance between tracks (310) and gear heads (332). In-so-doing unwanted moment is reduced, which decreases stress on the track (310) and track-mating parts (320), while reducing binding. The two trailing-edge (202) motors are replaced with trailing-edge stabilizers (350). The trailing-edge stabilizers of Embodiment A2 (FIG. 9) comprise springs that push freely-spinning gears heads (332) against the rear rack (341) to stabilize and smoothen moveable-section (2) translation.

Gear heads (332) and racks (341) can be replaced by a pegged gear (333) and a pegged rack (342, FIG. 9), a simple tongue-and-groove system, a rod-and-slot, or some other set of mating parts with or without spring-loading to stabilize and smoothen moveable section translation. Lubrication and/or bearings may also be included.

### Embodiment A3

Embodiment A3 is depicted in FIG. 10. It is equivalent to Embodiments A1 and A2, except that it omits parts near the trailing edges (202) of the moveable sections that are not strictly necessary (e.g. 330, 340, 350).

### Embodiment A4

Embodiment A4 is a preferred embodiment of the actuation system (3); it is depicted in FIG. 11. Embodiment A4 has two laterally-oriented T-slot (311) tracks (310). One track (310) is located on the inner-upper surface of the fixed-section (1), and the other (310) is located on the inner-lower surface of the fixed-section (1). The two tracks (310) have corresponding T-slider (321) track-mating parts (320). The track-mating parts (320) are disposed near the roots and quarter-chord lines (209) of the moveable sections (2). The driving element (330) is one motor (331) with one gear head (332) placed near the root of each moveable section (2). The engaging elements (340) are one toothed rack (341) that runs laterally along the upper track (310), and another (342) that runs laterally along the lower track (310).

### Embodiment A5

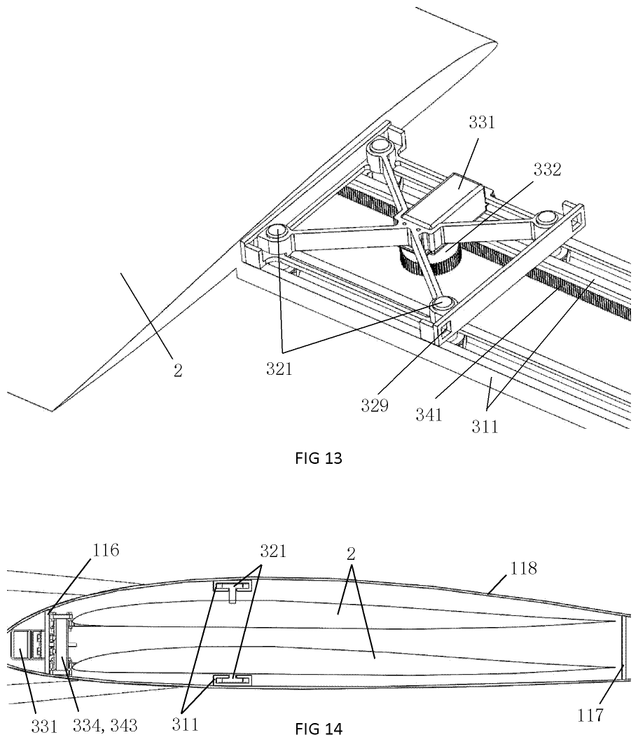

Embodiment A5 utilizes two parallel tracks (310) per moveable section (2) in the form of T-slots (311). One set of parallel tracks (310) is located near the inner-upper surface of the fixed-section (1). Another set of parallel tracks (310) is located near the inner-lower surface of the fixed-section (1). Each tracking mating part (320) has a frame (325) that comprises a surrounding rectangular structure with an internal X-shaped structure that runs approximately corner-to-corner. For the version of Embodiment A5 depicted in FIG. 13 there is a threaded hole near each corner of the frame (325). A threaded element (in this case a nylon bolt) screws into each of the threaded holes; the head and shaft of each threaded element form a T-slider (321).

Alternatively, the nylon bolts can be replaced by tubular shafts and a rolling element (323, like a bearing) can be disposed on each tubular shaft. The inside of the tubular shaft can be threaded such that a threaded fastener can be used to pinch each rolling element (323) onto its corresponding tubular shaft. In this case, the rolling elements (323) would act like the heads of the nylon bolts previously-mentioned, but with less friction. In this case, the rolling elements (323) and the threaded fasteners would simultaneously fit within the tracks (310).

A motor (331) attaches to the frame (325); it has a gear head (332) attached to its (331) output shaft. The gear head (332) meshes with a rack (341) that runs along one of the fixed parallel tracks (310) in each set. The motor (331) drives gear head (332) rotation, which drives lateral translation of the moveable sections (2).

The left and right sides of the frame's (325) rectangular structure have frame holes (329). The frame holes (329) accommodate spars (213) that run through each frame (325) and its corresponding moveable section (2) for a strong and rigid connection. The two parallel-tracks per moveable section design of Embodiment A5 results in better structural support to withstand high torsional loads about a moveable section (2).

### Embodiment B

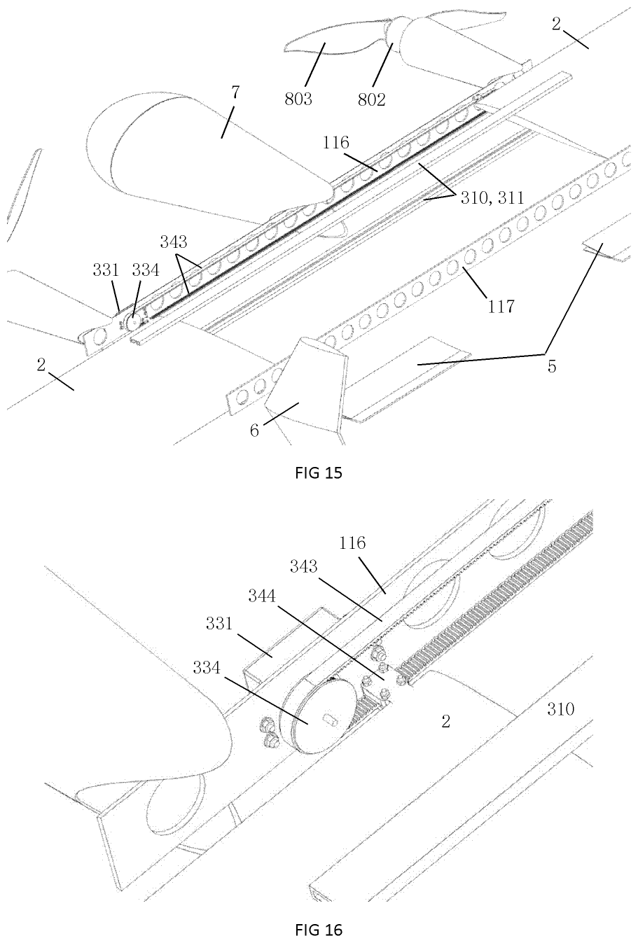

Moveable section (2) translation is equal in magnitude and opposite in direction. As a result, an aircraft's wing (fixed+moveable sections) always remains symmetric about the plane-of-symmetry (114) except for minor vertical-offset, when vertical-offset is used. Geometric symmetry allows the aircraft to maintain balanced flight at every translational position and it allows both moveable sections to be actuated using a single motor (331), as depicted in FIGS. 14-16.

There is a disc-like element (334) placed within the fixed-section (1) near a leading-edge (101) tip. The disc-like element (334) is driven by a motor (331) that is attached to the forward spar (116). The motor (331) has a gearbox, which increases torque and slows rotation.

A long loop-like element (343) connects the disc-like element (334) to another disc-like element (334) of equivalent diameter that passively-rotates. The passively rotating disc-like element (334) is located within the fixed-section (1) near the other leading-edge (101) tip. As the motor (331) rotates the loop-like element (343) moves such that its upper and lower segments move in opposite directions. Moveable sections (2) or track-mating parts (320) are attached to the loop-like element (343) using a loop-to-section attaching means (344).

The nature of the loop-to-section attaching means will depend upon the particular loop-like element (343) used. For example, the loop-to-section attaching means (344) could be a clamp that is attached to a moveable section (2) or a track-mating part (320) and which is further pinched onto the loop-like element using threaded fasteners or even a pair of pliers. The clamp could be a simple piece of metal, or a belt clamp, or a hose clamp. Alternatively, a collar could be attached to the loop like element (343) which further interlocks with a moveable section (2) or a track-mating part (320). A piece of wire could be wrapped-around or threaded through a track-mating part (320) and then wrapped around a loop-like element or a simple adhesive could be used as the loop-to-section attaching means.

The upper moveable section is attached to the upper segment of the loop-like-element (343) and the lower moveable section is attached to the lower segment of the loop-like element (343). When the motor (331) and its corresponding driving element (334) rotate one direction the moveable sections (2) translate outward, when the motor (331) rotates in the other direction the moveable sections (2) translate inward.

A second set of a loop-like element and disc-like elements can be added near the rear spar (117). The rear loop-like element and disc-like elements can rotate passively or be driven by an additional motor (331). Alternatively, the motor shaft from the front motor can be extended to simultaneously drive disc-like elements at the front and rear of the fixed-section (1).

One advantage of Embodiment B is that utilizing one motor (331) can increase safety and reliability. For example, if one Embodiment A4 motor (331) fails then one moveable section (2) will move and the other will remain stationary. Forces and moments will become unbalanced and the aircraft will likely crash. If Embodiment B's motor (331) fails then the two sections (2) will stop at equal-and-opposite lateral positions allowing control of the aircraft to be maintained.

A disadvantage of Embodiment B is that its parts take-up more room within the fixed-section (1), which forces design compromises. For example, spars (116, 117) might have to be moved further apart, which weakens the structure of the fixed-section (1) and reduces its stiffness. Alternatively, moveable-section (2) chord-lengths (207) might be reduced, which decreases the amount of wing area added by the fully-extended moveable sections. For Embodiment B the fixed section will tend to be more crowded, which can also frustrate manufacturing and assembly.

### Embodiment C

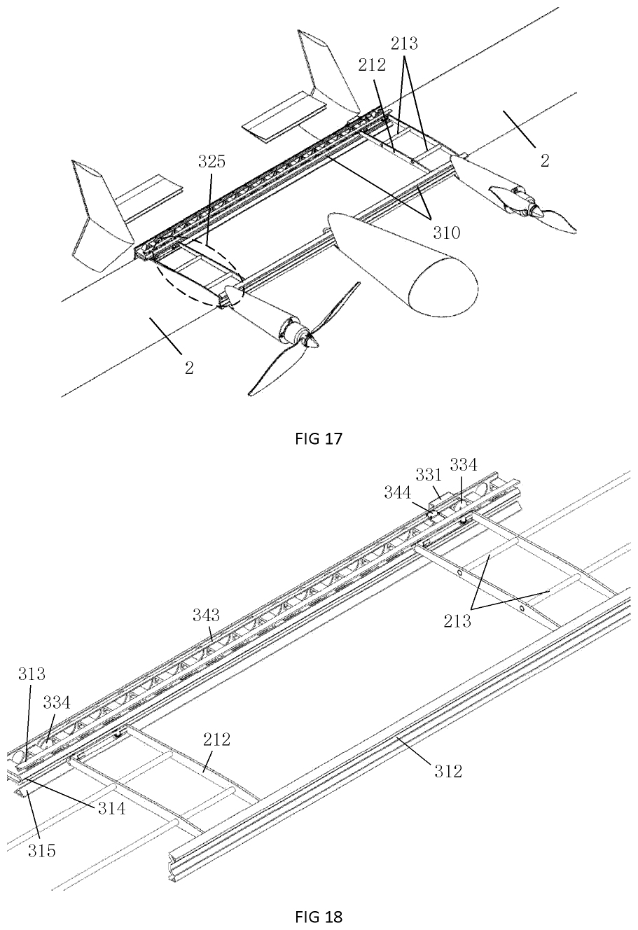

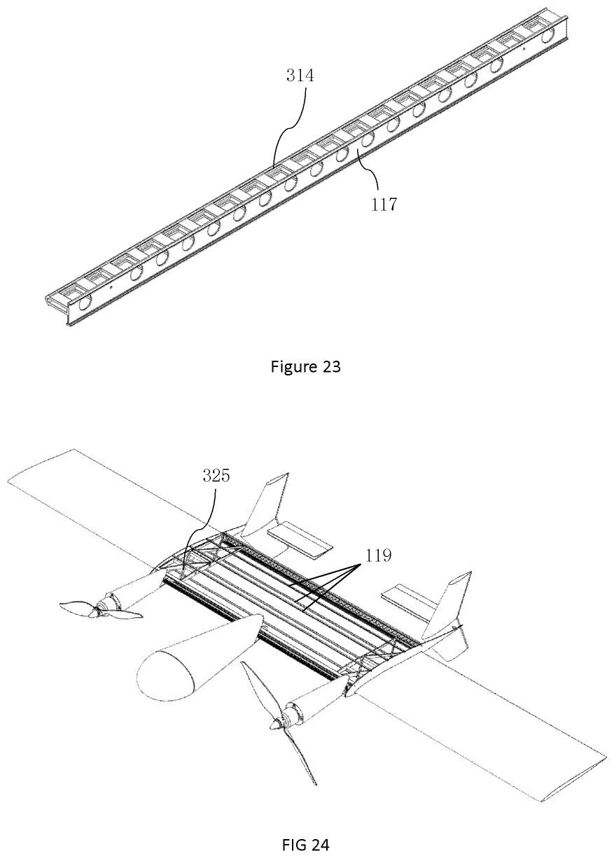

The variable-span wing may experience moveable-section binding when applied to certain aircraft subjected to certain loading conditions. For such cases tracks (310) and track-mating parts (320) can be designed to specifically avoid binding, as depicted in FIGS. 17-23.

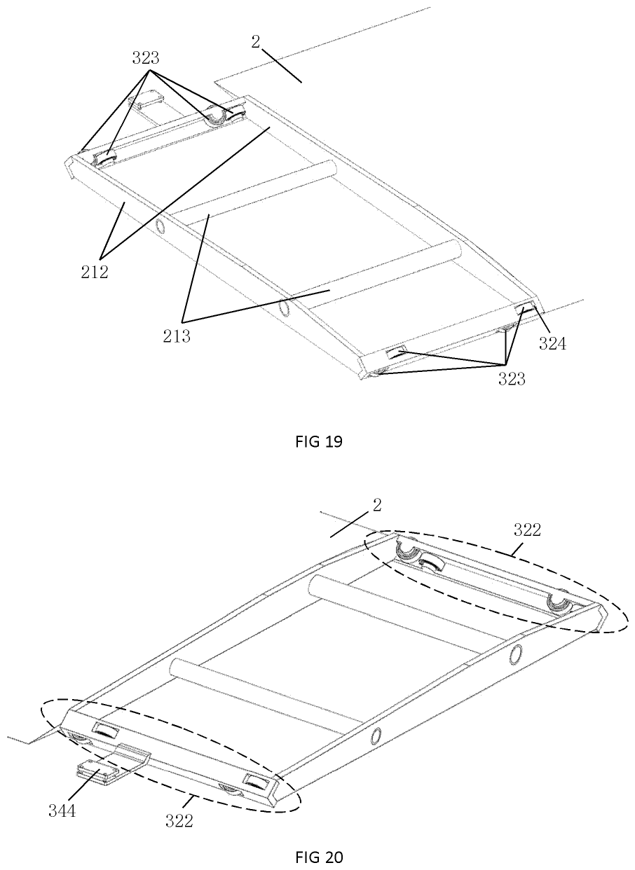

Track-mating parts (320) are attached to a framework comprising two airfoil-shaped ribs (212) and two tubular spars (213) per moveable section (2), as shown in FIG. 17. The spars (213) run through ribs (212) and a moveable section (2), joining them (FIG. 18). Track-mating parts (320) comprise angle-sliders (322), which comprise two perpendicular planes of material that attach to the airfoil-shaped ribs (212), as depicted in FIG. 19. The angle-sliders (322) are oriented such that each of the two main planes are offset approximately 45 degrees from the horizontal plane (115). There are two slots (324) cut into each plane of material for each angle-slider (322). These slots (324) allow rolling elements (323) to pass through the angle-sliders (322) and protrude outward toward the tracks (310). The inner ring of the rolling elements (323) is attached to the angle-sliders (322). The outer ring of the rolling elements (323) is free to rotate with respect to the inner ring. The outer cylindrical surface of the rolling elements (323) contacts the tracks (310). Forces transmitted between the tracks (310) and track-mating parts (320) flow through the contacting surfaces. The rolling elements (323) rotate along the tracks (310) as moveable sections (2) translate. An loop-to-section attaching means (344) is attached to the rear angle-slider (322) in the form of a belt clamp, as seen in FIG. 20.

Tracks (310) run almost the full-span of the fixed section (1) near both its leading (101) and trailing (102) edges (FIG. 17). Tracks (310) comprise planes of material offset 90 degrees from one-another. The planes of material are offset approximately 45 degrees from the horizontal plane (115). They form two V-shaped angle-channels (312), one for the upper moveable section's track-mating parts (320), and one for the lower moveable section's track-mating parts (320). The front tracks (310) can attach to the fixed-section's (1) forward spar (116), or the tracks (310) can act as both tracks (310) and the forward spar (116) simultaneously while connected to the inner-upper and inner-lower surfaces of the fixed-section's skin (118).

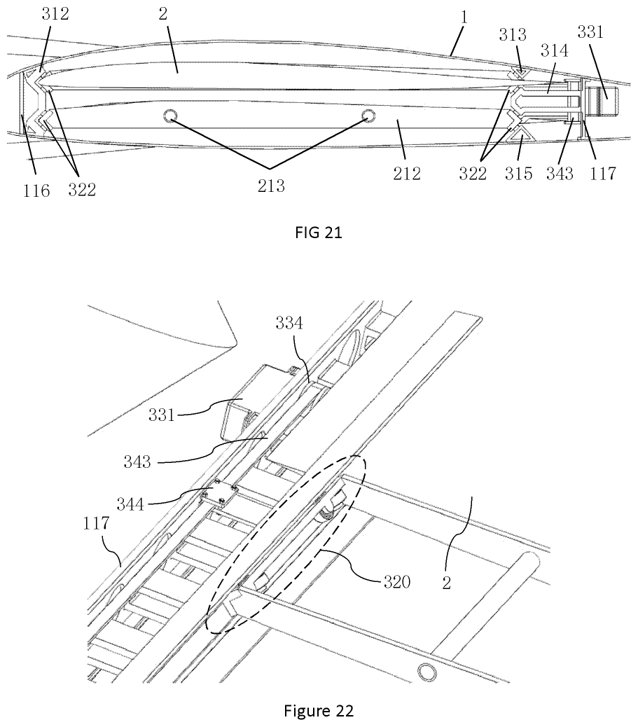

The rear track (310) has to accommodate the trailing edges (202) of the moveable sections. The trailing edges (202) of the moveable sections are sharp and thin, making them unsuitable for attachment of angle-based track-mating parts (320), as implied by FIG. 21. Therefore, track-mating parts (320) are attached to moveable sections (2) further upstream. The central track (314) attaches to the fixed-section's (1) rear spar (117) and protrudes forward between moveable section (2) trailing edges (202). The rear track (310) features two triangular parts (313, 315). The upper triangle (313) is attached to the inner-upper surface of the fixed-section's skin (118) and the lower triangle (315) is attached to the inner-lower surface of the fixed-section's skin (118). The three parts (313, 314, 315) together form two V-channels, one for the upper moveable section (2) and one for the lower moveable section (2).

Embodiment C utilizes the motor (331), loop-like element (343), and disc-like elements (334) of Embodiment B, but with the driving motor (331) attached to the rear spar (117) instead of the front spar (116). Embodiment C has the advantage of making moveable sections (2) bind-proof, but Embodiment C is more complicated, expensive, and heavier than previous embodiments.

### Embodiment D

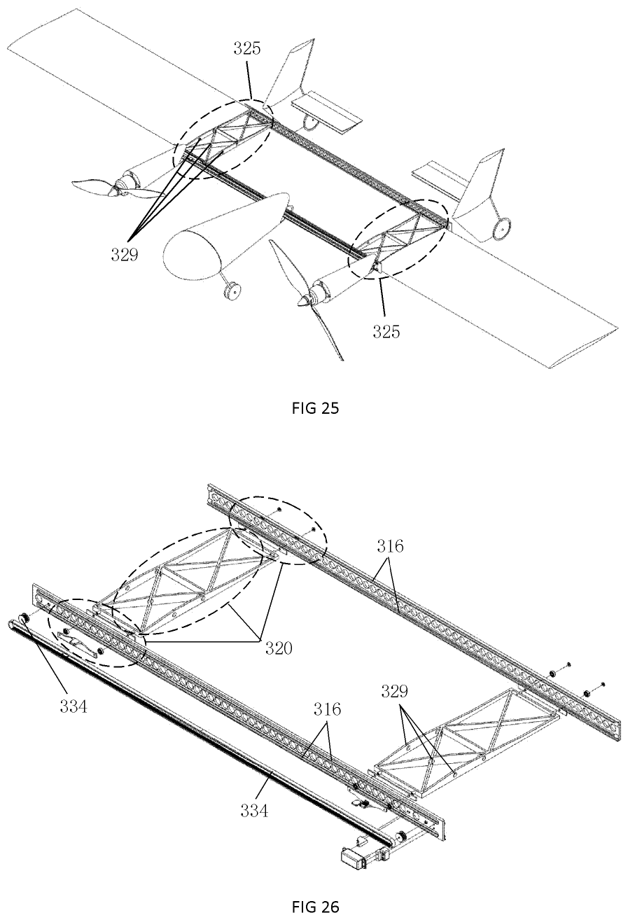

Embodiment D provides an example of the variable-span wing with spar-integrated tracks (310) and spanwise stringers (119), as seen in FIG. 24. The stringers (119) help support fixed-section skin (118) against excessive deformation while maintaining a large unobstructed internal space to accommodate moveable sections (2). At the root of each moveable section (2) is a double X frame (325) to enhance rigidity and strength (FIG. 25). The frames have holes (329) to accommodate spars (213, FIG. 26). The spars (213) are adhesively joined to the moveable sections (2) and frames (325); spars (213) pass through the holes (329) in the frames (325) and into corresponding holes in the moveable sections (2).

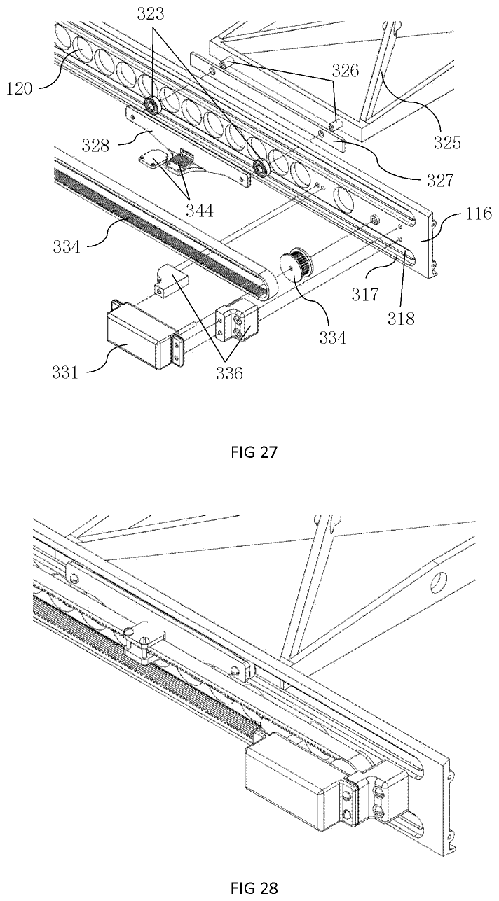

Track-mating parts (320) are actuated using a motor (331), loop-like element (343), and disc-like elements (334), which are shown exploded and close-up in FIG. 27. The forward track-mating parts (320) for each moveable section (2) have a loop-to-section attaching means (344) that forces them to move with the loop-like element (343). The corresponding frame (325) transfers the pull of the belt (343) to the corresponding rear track-mating parts (320). The forward and the rear track-mating parts (320) comprise two separated bearings (323) that are constrained to move along slot-like tracks (316, FIG. 26). The slot-like tracks (316) run parallel to the direction of moveable section (2) translation. The slot-like tracks (316) comprise an inset slot (317) that does not pass all-the-way through its material, as well as a colinear slot (318) of lesser width that does pass all-the-way through its material (FIG. 27).

The forward bearings (323) are sandwiched against the inset slot (317) using two plates (327, 328), as in FIG. 27. One plate directly contacts the spar (116)—it is the sliding plate (327). The other directly contacts the bearings (323)—it is the bearing plate (328); the plates (327, 328) need-not be rectangular. The sliding plate (327) is made of nylon, teflon, or some other low-friction material.

Frames (325) have tubular ports (326) with threading on their inner-surfaces (FIG. 27). The ports (326) pass through the sliding plate (327), slot-like tracks (316), and bearings (323). The bearing plate (328) is pinched against the ports (326) using threaded fasteners (FIG. 28). The rear track-mating parts (320, FIG. 26) do not utilize a loop-to-section attaching means (344), so it is convenient for their bearing plates (328) to take the form of washers.

Two spacers (336) shift the motor (331) away from the tracks (310) to provide space for a toothed pulley (334, FIG. 27). Spacers (336) are attached to the spar (116) using threaded fasteners (FIG. 28). Threaded fasteners are also used to attach the motor (331) to the spacers (336). The inboard spacer (336) is narrower, which allows the loop-to-section attaching means (344) to pass over and under it without contact.

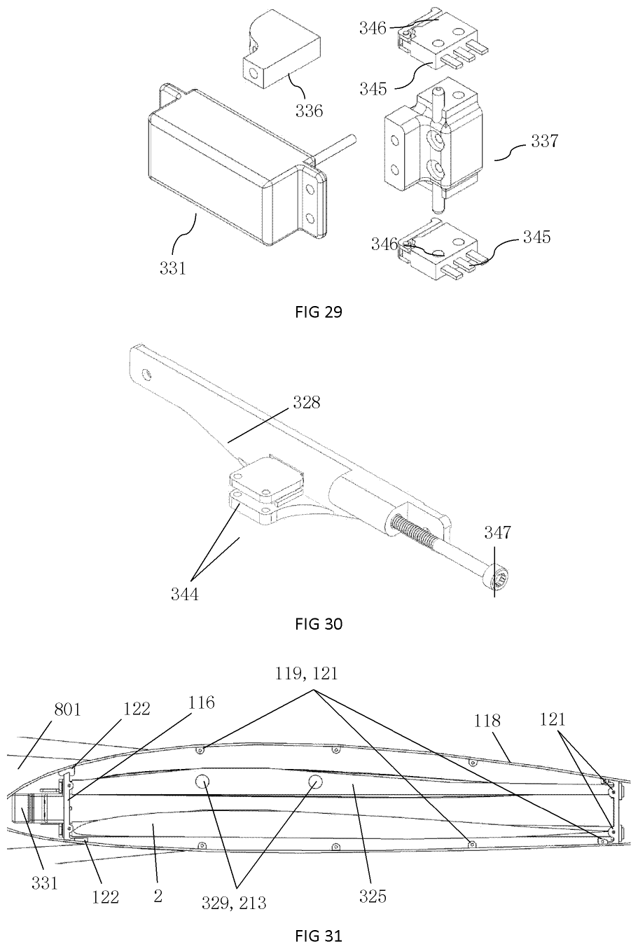

Electronic stops (345) can be added to Embodiment D, as shown in FIG. 29. When a bearing plate (328) hits the trigger (346) of an electronic stop (345) the motor (331) will stop spinning in the direction that causes translation against the stop (345). Two electronic stops (345) should be used to prevent over-extension or retraction of moveable sections (2). To keep wires short both electronic stops (345) can be placed on the motor-side of the fixed-section (1). It is convenient to attach electronic stops (345) to a modified spacer (337), as shown in FIG. 29.

A calibration bolt (347) can be disposed on each bearing plate (328), as seen in FIG. 30. Moveable section translation end-points can be set by carefully-adjusting the calibration bolt (347) until one of its ends strikes a corresponding trigger (346) at the exactly-desired translational position.

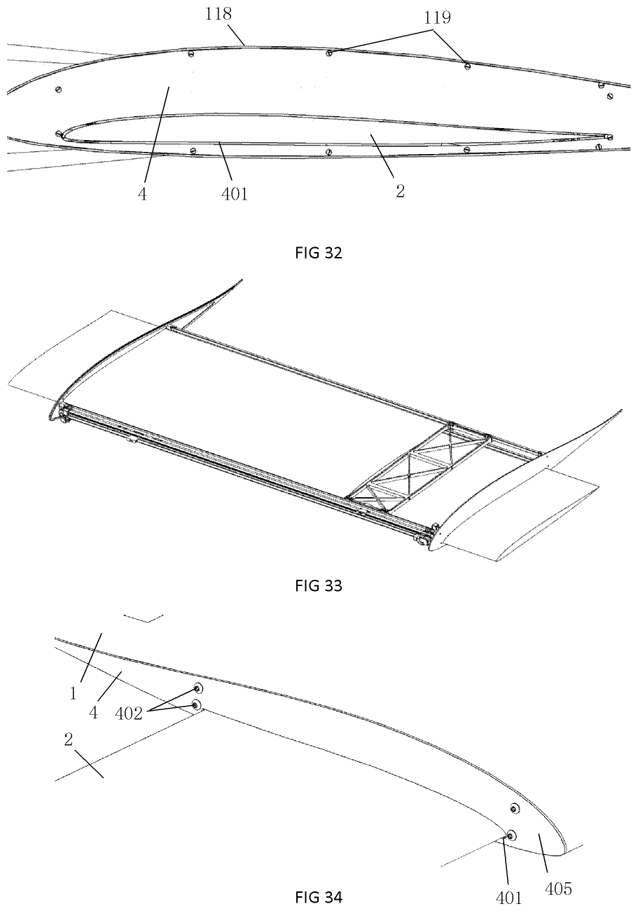

Spanwise-running stringers (119) for Embodiment D are depicted in FIG. 29. End cover (4) installation holes (121) may be placed at the tips of stringers (119) and spars (116, 117) to facilitate installation of end-covers (4). Special stringers (122) can be used to allow fixed-section spars (116, 117) to slide into and out of the fixed-section (1) whenever the end covers (4) are removed. This feature makes it easy to install, repair, and/or replace components within the fixed-section (1), including: spars (116, 177), tracks (310), track-mating parts (320), motors (331), belts (343), pulleys (334, 335), and frames (325). The spars (116, 117) are held in-place by special stringers (122) and by their attachment to the end covers (4), which are further attached to the ends of the other stringers (119). End covers (4) should be sized such that they slide slightly into the fixed section (1) to provide support to the fixed-section's skin (118) around the skin's inner-outboard periphery. An installed end cover (4) is depicted in FIG. 32.

### Embodiment E

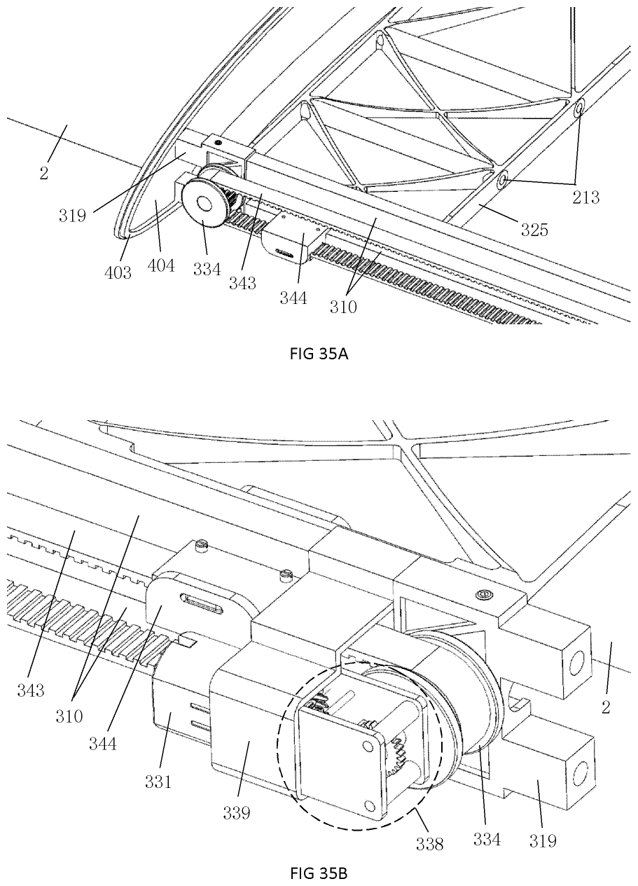

Embodiment E is depicted in FIG. 33. An end cover (4) for Embodiment E is depicted in FIG. 34. The right and left end covers each have a flange (403) that protrudes inwardly from the inner face of the end cover (4) near its periphery, as seen in FIG. 35A. The flange (403) is shaped like the tip-airfoil of the fixed section (1). The flange (403) fits into the tip of the fixed section skin (118) and helps to support the fixed section skin (118). The area outside of the flange (403) presses up against the tip of the fixed section skin (118) such that the end cover is automatically aligned and cannot slide out-of-place or further into the fixed-section (1). The end cover (4) can be manufactured using a simple 3-axis CNC machine.

The end cover (4) has holes to accommodate threaded fasteners (402). The threaded fasteners (402) pass through the holes in the end covers (4) and screw into threaded holes in end caps (319). The end caps (319) slide over the tracks (310) at the outboard edges of the tracks (310) and are fixed to the tracks using threaded fasteners, as seen in FIG. 34. As a result, the tracks (310) themselves utilize a constant cross-section for ease-of-manufacturing via extruded aluminum or a straight cut-through solid block of material. The end caps (319) can be fabricated using a 3-axis CNC machine with additional drill-through holes (tapped or untapped) to accommodate the threaded fasteners (402) coming through an end cover (4). Attachment of the end caps (319) to the tracks (310) and further attachment of the end caps (319) to the end covers (4) ensures proper alignment, orientation, and positioning of the tracks for smooth moveable section (2) translation.

The end caps (319) depicted in FIGS. 35A and 35B represent just one of many potential cover-to-track attaching means that would ensure proper alignment, orientation, and positioning of the tracks within the fixed-section. For example, plastic plugs with holes for threaded fasteners (402) could be used where the plastic plugs are pushed into each end of each track (310) and glued in-place. In that case, the end covers (4) could be attached to the tracks (310) through the plastic plugs. That said, it is recommended to avoid a permanent plug-track connection so the plugs can be removed for easy detachment of the track-mating parts (320) from the tracks (310) by sliding the track-mating parts (320) out of one end of the tracks (310). Another cover-to-track attaching means could be to weld or solder a metal plate or an end cap (319) to the ends of each track (310), with holes added for the threaded fasteners (402). Alternatively, the tracks (310) could be manufactured without constant cross-sections such that the cover-to-track attaching means could be innate to the tracks (310). End caps (319), plugs, or plates could also be attached to the tracks (310) or to the end covers (4) using one of many potential snap-in, pop-in, or twist-in methods. The cover-to-track attaching means could also be disposed on the end covers (4). For example, track-flanges could be disposed on the end covers (4) into which the tracks would directly slide and/or snap-in.

A direct or indirect locking connection between the end covers (4) and the tracks (310) is not strictly necessary. For example, an end cover (4) could be prevented from slipping-away from a fixed-section tip-opening by attachment of the end cover (4) to stringers (119, FIG. 31) or to a rib located near a tip of a fixed-section (1). The corresponding end cover (4) is then fixable without a locking connection to the tracks such that the tracks (310) could be properly-oriented, positioned, and held in-place by sliding the tracks (310) into corresponding flanges or grooves in the end covers (4) prior to fixing the end-covers in-place. This type of method also constitutes a cover-to-track attaching means.

The version of Embodiment E depicted in FIG. 33 utilizes a loop-like element (343), disc-like element (334), and a loop-to-section attaching means (344), as seen in FIGS. 35A and 35B. Each disc-like element (334) is attached to an end cap (319). The upper and lower segments of the loop-like element run parallel to the tracks (310). Two tracks (310) run spanwise and parallel to one-another near the leading edge (101) of the fixed-section (1). The two tracks are stacked such that one is above and the other. Another two tracks run spanwise and parallel to each other further downstream and are stacked such that one is above the other. The four tracks all run spanwise and parallel to each other. The two upper tracks accommodate track-mating parts (320) for the top moveable section (2) while the two lower tracks (310) accommodate track-mating parts (320) for the bottom moveable section (2). Notice that the tracks (310) are positioned front-and-back rather than top-and-bottom on the skin (118), as was the case for the embodiments depicted in FIGS. 5-15.

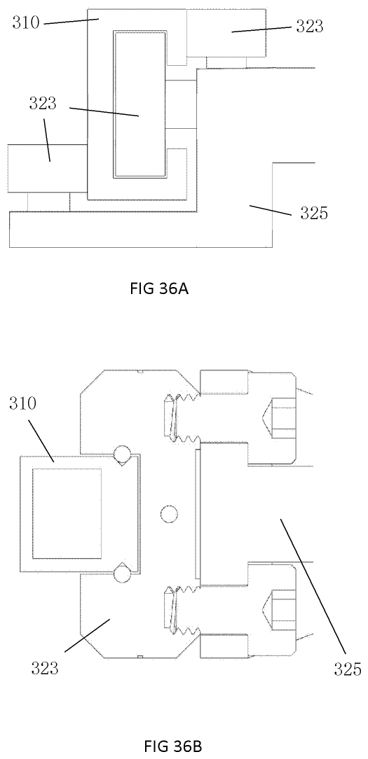

Tracks (310), track-mating parts (320) and rotating elements (323) can be oriented relative to one-another in many different ways. Cylinder-shaped rolling elements (323) are designed to be loaded at their outer cylindrical surfaces. The greatest force exerted on a moveable section (2) is the lift force, which is primarily upward. The primary rolling-elements (323) and tracks (310) should be oriented such that the lift force does not push the sharp circular edge of a primary cylindrically-shaped rolling element (323) against a track (310), but rather causes the outer cylindrical surface of the primary cylindrically-shaped rolling elements (323) to be pushed against the track (310) such that there is no tendency to bind. An example orientation for cylindrically-shaped rolling elements (323) is provided in FIG. 36A, which is a sectioned side-view. The lift force will be transmitted to the track through the outer cylindrical surface of the primary rolling element (323), which is centrally-located. The two outer rolling elements (323) prevent the primary rolling element from scraping against an inner sidewall of the track (310).

Alternatively, the rolling elements (323) may be linear bearings that include spherically-shaped ball bearings, as depicted in FIG. 36B and described in “DEFINITIONS”. Here the track (310) is a rectangular tube with triangular grooves cut into its upper and lower surfaces. Ball bearings roll within the linear bearings and within the triangular grooves to reduce resistance-to-motion.

FIG. 35B of Embodiment E depicts a motor (331) and gear set (338) that drive rotation of a disc-like element (334) for moveable section actuation. The motor (331) and the gear set (338) are attached to the tracks (310) using a motor installation bracket (339). The motor installation bracket (339) slides over one end of the two front tracks (310) prior to installation of the corresponding end cap (319). The motor installation bracket (339) is held in-place using threaded fasteners, adhesive, or by welding. The motor (331) slides into the motor installation bracket (339) and is held in-place using threaded fasteners that pass through a plate on the motor installation bracket and into threaded holes disposed on the circular front-face of the motor's shell. The rearward set of tracks (310) do not include a motor (331), pulleys (334), or a belt (343).

The inner assembly of the FIG. 33-35B version of Embodiment E comprises: two moveable sections (2), four tracks (310), four end caps (319), one motor installation bracket (339), one motor (331), one gear set (338), two disc-like elements (334), one loop-like element (343), and two sets of track-mating parts (320) that include frames (325), a loop-to-section attaching means (344), and rolling elements (323).

For installation the entire inner assembly can be attached to one end cover (4) and then slid into the fixed-section (1) from an open tip of the fixed section (1). The electrical wire for the motor (331) must be connected to a power and to a signal source. Next, the other end cover (4) is installed at the other tip of the fixed section (1) using threaded fasteners (402). The inner assembly is sandwiched between the end covers (1). The end covers (4) are held in-place due to the inner-contact between the skin (118) and flanges (403) as well as the contact between the end cover area surrounding the flanges (403) and the tips of the fixed-section skin (118). Attachment of the end covers (4) to the tracks (310) prevents them from sliding outward away from the fixed-section (1). All of the parts of the inner assembly are thus automatically aligned and ready for use. The inner assembly can be removed by removing one end cover (4), disconnecting wires from the motor (331), and then sliding the inner assembly laterally out of the fixed section (1) through one of its tip openings. There is no need for any skin cut-outs or wing panels which would weaken the structure of the fixed section. Embodiment E is the most-preferred embodiment of the variable-span wing because it is easy, convenient, and inexpensive to manufacture, install, and maintain. Unlike Embodiment D, there is no need to precisely manufacture, align, and position an array of stringers (119) or special stringers (122) to which end covers (4) are attached.

The modular design of Embodiment E allows an aircraft to be optionally flown without its inner assembly when desired. Modularity also allows-for updated inner assemblies to be utilized when there are design improvements. The inner assembly should not be interpreted to strictly include all of the components as-depicted in FIGS. 35A and 35B. For example, the inner assembly can consist of a variety of different sets of components. A separate motor could be attached to each moveable section and have a gear head (332) on its shaft that engages with a rack (341) to drive moveable section translation, as previously depicted in FIGS. 7-12. In fact, the inner assembly need-not include moveable sections (2) at all, as virtually any parts or components could be installed and uninstalled through a fixed-section tip-opening including a special an array of sensors or extra batteries.

### Aircraft Applicability

The variable-span wing can be applied to many types of aircraft. Some example applications are presented and discussed below.

### Tail-Sitter

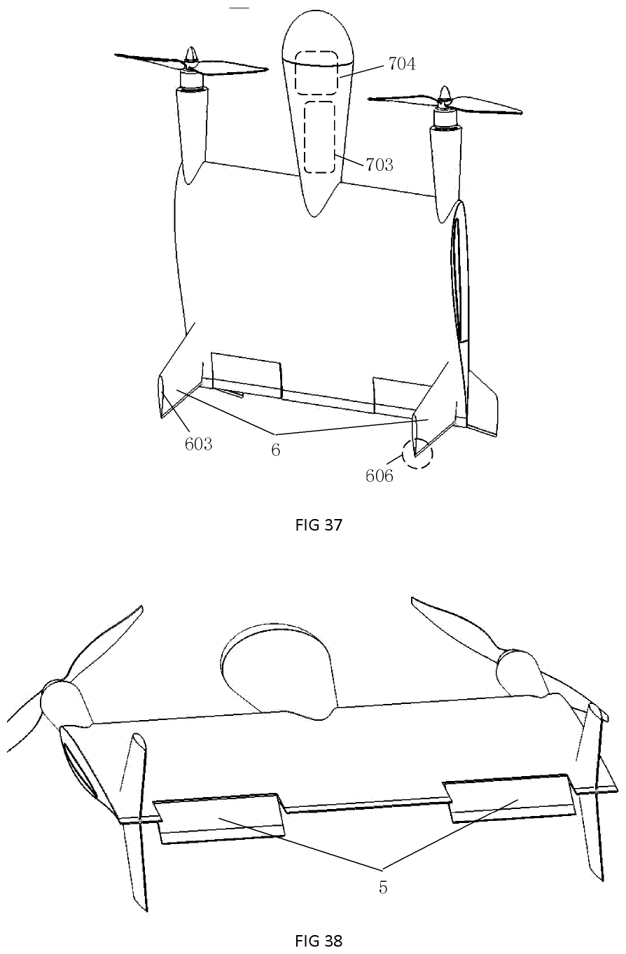

The variable-span wing is depicted as part of a small tail-sitting VTOL aircraft. The aircraft can sit on its tail-parts (FIG. 37). It can takeoff vertically, hover, then transition from a vertical orientation to a horizontal one. As it pitches-over to a horizontal orientation it accelerates and flies like a conventional airplane. When it is ready to land it pitches upward and hovers. It then beings a slow vertical descent until it comes to rest on the ground. Its VTOL ability allows the aircraft to operate without runways and to fly “low-and-slow” in cluttered environments while enjoying the speed, range, and endurance of conventional fixed-wing aircraft.

The aircraft has a flying-wing design; it is necessary to position the aircraft's center of mass forward (upstream) of its neutral point for passive longitudinal stability (pitch). The neutral point may also be referred to as the aerodynamic center of the aircraft. It is necessary to have internal space for the storage of various components. There is insufficient space within the wing to store moveable sections along with all of the components needed. Additional space to house components (receiver, batteries, etc.) is provided by the fuselage (7), as seen in FIG. 1. The fuselage (7) lies on the aircraft's plane of symmetry (114). It need-not take the form of a discrete component; it can be blended-into and indistinguishable-from the wing. The fuselage has a body (701) and may include one or more windows (702) or transparent sections to accommodate internal cameras. The mass of the battery (703) and electronics assembly (704) contribute to shifting the aircraft's center-of-mass (112) forward for longitudinal stability.

The aircraft has fins (6) that act as feet to stand on. The fins (6) ensure lateral stability (roll and yaw) during conventional flight. They do not have nor need moveable control surfaces because yaw is controlled using differential propulsive thrust. Fins (6) are kept short and placed downstream of the propellers (803) within the propulsive slipstream (804, FIG. 3A) to help prevent fin-stall during high yaw-rate or roll-rate maneuvering. The fins (6) are disposed near the outboard edges of the fixed-section (1) to diminish wingtip vortices when the moveable sections (2) are retracted. Being placed outboard also provides a wider-base for increased stability while standing. The fins (6) are swept-back to provide clearance between the trailing-edge (102) of the fixed section (1) and the ground. The fins (6) are tapered and utilize symmetric airfoils (603). Tapering improves aerodynamic efficiency and provides an appropriate lightweight structural shape to that can successfully resisting bending stresses during landing. Symmetric airfoils (603) are used to dampen unwanted yawing and rolling perturbations in both directions (positive and negative) and to prevent induced drag on the fins (6) during forward-flight.

The aircraft has two counter-rotating propellers (803) and propulsive motors (802) upstream of the wing. They are symmetrically disposed about the aircraft's plane-of-symmetry (114, FIG. 3A). The direction of propeller rotation about a forward-pointing axis is positive according to the right-hand rule for the aircraft-right propeller, and negative for the aircraft-left propeller. As a result, slipstream swirl opposes wing-tip vortices, which are caused by higher pressure air below the wing accelerating around wingtips toward lower pressure air above the wing. Wing tip vortices increase drag and reduce aerodynamic efficiency, especially for low aspect ratio wings. When the moveable sections are retracted (FIG. 2) the wing has a very low aspect ratio and its counter-rotating propellers (803) are located at its wingtips.

The propulsive motors (802) provide sufficient power for the propellers (803) to generate thrust significantly in excess of the weight of the aircraft. The propulsive motors (802) are attached to nacelles (801) that protrude upstream from the wing's leading edge, which helps to shift the center-of-mass forward for improved longitudinal stability.

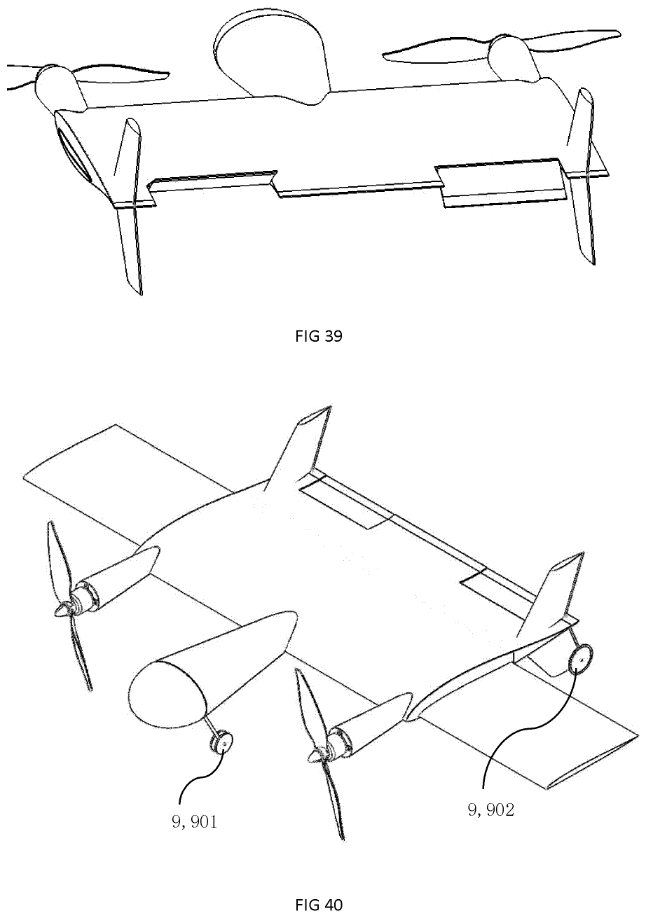

The aircraft has two moveable control surfaces called elevons (5), which are symmetrically-disposed about the aircraft's plane-of-symmetry (114) near the wing's outboard trailing edge. The elevons (5) can deflect symmetrically to provide pitch control (FIG. 38) or differentially to provide roll control (FIG. 39). To function the elevons (5) must have a flow of air over them, which is traditionally provided by a strong freestream. The present unconventional tail-sitting aircraft also needs a flow of air over its elevons (5) during hovering flight, so the elevons (5) are positioned behind the propellers (803). The propeller slipstreams (804) provide a strong flow of air over each elevon (5) during takeoff, landing, very low-speed flight, and hover.

If a user would like conventional takeoff and landing as an option then landing gear (9) can be installed. A tricycle configuration is recommended with one nose wheel (901) and two rear wheels (902), as depicted in FIG. 40.

### Multi-Rotor

A winged multi-rotor “jump” type VTOL aircraft is less gust-sensitive than a tail-sitter because its wing is not oriented broadside to the wind while hovering. By combining a multi-rotor with the variable-span wing a designer can achieve excellent hovering performance even in stormy conditions. It also allows users to enjoy the benefits of higher dash speeds, more efficient flight over a wider range of cruise speeds and the other benefits that a variable-sweep wing provides, as previously-described.

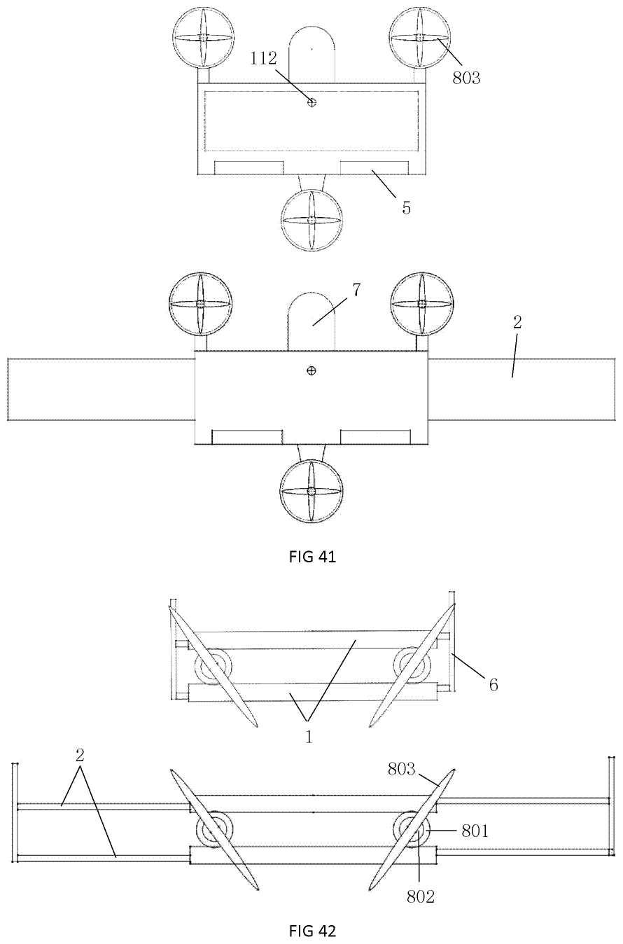

An example of a VTOL multi-rotor application is presented in FIG. 41. For this application it is necessary to have at least three propellers; four or more could be used. For balance and control during hover it is necessary to have at least one propeller forward of the aircraft's center of mass, at least one aft of the aircraft's center of mass, at least one propeller to the left of the aircraft's center of mass, and at least one propeller to the right of the aircraft's center of mass, as depicted in FIG. 41. All of the propellers together must create enough upward thrust to allow the aircraft to hover.

The VTOL multi-rotor must have a means of creating forward-thrust for propulsion, which can be achieved using one or more propellers that point forward. To avoid carrying unnecessary “dead weight” while hovering it is preferable to use one or more propellers that can point upward during hover and tilt forward at least 60 degrees for forward-flight. For the example aircraft the two forward propellers can tilt-forward approximately 90 degrees.

Differential thrust is used to control rotation of the aircraft about one or more axes during hovering flight. A difference in left-right thrust produces a roll input while a difference is forward-aft thrust produces a pitch input. If an even number of propellers are used then half will rotate clockwise and the other half counter-clockwise such that the reactionary moment on the airframe will be zero. Furthermore, providing more power to clockwise propellers and less to counter-clockwise propellers produces a nonzero net reactionary moment that can be used for yaw control.

During conventional forward-flight control can be achieved many ways. For FIG. 41 the rear propeller can be used for pitch-control (if it doesn't rotate backward to produce forward thrust). Alternatively, an elevator can be used for pitch control, or two elevons. Two elevons could also provide roll-control, or asymmetrical extension of moveable sections can be used for roll control.

### Biplane

An example of a biplane application is provided in FIG. 42. It comprises two variable-span wings that are vertically-offset from one-another. The two variable-sweep wings can also be offset from each-other longitudinally, which is generally preferable for overall aerodynamic performance. Each wing comprises one fixed-section, two moveable sections, and a moveable section actuation system. Moveable sections overlap within the fixed-sections. Actuation systems utilize tracks and track-mating parts.

The biplane has two nacelles (801), propulsive motors (802), and propellers (803) located upstream of the leading edge (101) and toward the outboard edges of the fixed-sections (1). Moveable section wingtips for the upper and lower wings have been joined using combination fins/winglets (6) that provide lateral stability, tip vortex reduction, and structural reinforcement.

Flying-Wing with Sweep

The variable-span wing system may also be used with highly-swept wings and delta wings, as depicted in FIG. 43. Moveable sections are actuated in a similar manner as with previous cases utilizing tracks and track-mating parts, but for highly-swept wings it is impractical to overlap the moveable sections. Therefore, the moveable sections do not overlap when fully retracted. As a result the maximum span of each moveable section is approximately halved, which reduces the magnitude of potential benefits provided by the variable-span wing.

Airplane with Dihedral

Variable-span wings can be applied to conventional airplane designs. FIG. 44 illustrates an application where the aircraft has one wing and an empennage in the form of a T-tail. The wing has a mean dihedral angle greater than 3 degrees for excellent roll-stability, but the high dihedral (124) prevents moveable sections from overlapping when fully retracted. The empennage comprises control surfaces designed to provide pitch and roll control for the aircraft.

For conventional aircraft one should consider the horizontal stabilizer and tail-parts to preserve longitudinal stability during moveable section extension. Example techniques include: using a variable-span wing system for the horizontal stabilizer, and/or changing its angle of incidence, using symmetric or slightly-reflexed airfoils (203) for the moveable sections, and/or using and appropriate combination of sweep (123) and twist for the moveable sections.

### Disclaimer

The scope and spirit of the variable-span wing encompasses similar systems that affect a significant change in span of substantially wing-similar aerodynamic surfaces, including: horizontal stabilizers, vertical stabilizers, fins, winglets, and V-tail parts.

While the foregoing written description of the aircraft and variable-span wing enable a person having ordinary skill in the art to make and use what is considered presently to be the best mode thereof, those of ordinary skill in the art will understand and appreciate the existence of variations, combinations, and equivalents of the specific embodiments, processes, and examples herein. The invention should therefore not be limited by the above described embodiments, processes, and examples, but by all embodiments and processes within the scope and spirit of the invention.

1. A variable-span wing for aircraft comprising:
(a) a fixed-section; the fixed-section comprising:
(i) fixed-section skin;
(1) where the fixed-section skin forms a lift-generating wing surface;
(ii) fixed-section airfoils, some of the fixed-section airfoils comprising:
(1) a round leading edge; and
(2) a relatively sharp trailing edge;
(iii) a left tip, the left tip comprising a tip opening;
(iv) a right tip, the right tip comprising a tip opening;
(b) a top and a bottom moveable section, each movable section comprising:
(i) moveable-section airfoils, some of the moveable-section airfoils (203) comprising:
(1) a round leading edge; and
(2) a relatively sharp trailing edge; and
(ii) where the two moveable sections are vertically offset from one another;
(iii) where the top moveable section translates in substantially lateral directions through one of the tip openings into and out of the fixed-section;
(iv) where the bottom moveable section translates in substantially lateral directions through the other tip opening into and out of the fixed-section;
(v) where the two movable sections overlap each other within the fixed-section when fully-retracted;
(c) a set of sliding mechanisms designed to facilitate the two moveable sections to translate in substantially lateral directions into and out of the fixed-section, the set of sliding mechanisms comprising:
(i) at least two tracks; and
(ii) at least two track-mating parts;
(iii) where each track is located within the fixed-section;
(iv) where each track does not translate with the two moveable sections;
(v) where at least one of the track-mating parts is attached near the root of the top moveable section and translates along at least one of the tracks to guide the translation of the top movable section;
(vi) where at least one of the track-mating parts is attached near the root of the bottom moveable section and translates along at least one of the tracks to guide translation of the bottom movable section.

2. The variable span wing for aircraft according to claim 1,
(a) where at least some fixed-section airfoils
(i) have a maximum thickness greater than 6% of chord-length, and
(ii) have a maximum thickness greater than that of moveable section airfoils;
(b) where at least some moveable-section airfoils
(i) have a chord-length between 30 and 70% of the mean geometric chord-length of the fixed-section airfoils,
(c) where each moveable section when in a fully extended position has geometry that falls within the following angular magnitude limits:
(i) dihedral ≤3 degrees,
(ii) washout ≤5 degrees, and
(iii) leading-edge sweep ≤6 degrees.

3. The variable-span wing for aircraft according to claim 1, further comprising:
(a) a left and a right end cover, each end cover comprising an end cover hole;
(b) where the left end cover is located over the opening of the left tip of the fixed-section;
(c) where the right end cover is located over the opening of at the right tip of the fixed-section;
(d) where each end cover hole is sized and shaped to allow one of the moveable-sections to translate through the end cover hole.

4. The variable-span wing for aircraft, according to claim 1 further, comprising:
(a) one or more electronic stops;
(b) where the one or more electronic stops are designed to prevent over-extension or over-retraction of corresponding moveable sections.

5. The variable-span wing for aircraft according to claim 1, further comprising:
(a) two driving mechanisms, where there is one driving mechanism for each of the two moveable sections, each driving mechanism further comprising:
(i) at least one motor; and
(ii) at least one gear head;
(iii) where the at least one gear head is attached to the at least one motor;
(iv) where the at least one motor is attached to its corresponding moveable section or to the track-mating part that is attached to its corresponding movable section;
(v) where the at least one motor is located near the root of the moveable section;
(vi) where the at least one motor translates with the moveable section;
(b) at least one rack;
(i) where the at least one rack does not translate with the moveable section;
(ii) where the at least one gear head meshes with the at least one rack;
(iii) where rotation of the at least one gear head against the at least one rack causes the moveable section to translate;
(iv) where the at least one rack is located within the fixed section;
(c) the set of sliding mechanisms:
(i) where each of the tracks runs substantially spanwise across most of the fixed-section;
(ii) where at least one of the tracks is located above the top moveable section near the inner-upper surface of the fixed-section's skin;
(iii) where at least one of the tracks is located below the bottom moveable section near the inner-lower surface of the fixed-section's skin.

6. The variable-span wing for aircraft according to claim 5, further comprising:
(a) a forward spar;
(b) where the at least one rack is disposed on the forward spar;
(c) wherein for each driving mechanism:
(i) there is one motor; and
(ii) there is one gear head;
(iii) where the gear head protrudes forward near the leading edge of the moveable section.

7. The variable span wing for aircraft according to claim 5,
(a) in which there are at least two racks;
(b) where one of the at least two racks is disposed on the track located above the top movable section near the inner-upper surface of the fixed-section skin; and
(c) where one of the at least two racks is disposed on the track located below the bottom movable section near the inner-lower surface of the fixed-section skin.

8. The variable span wing according to claim 1,
(a) in which there are four tracks, the four tracks consisting of an upper forward track, an upper rear track, a lower forward track, and a lower rear track;
(i) where the upper forward track, and the lower forward track are located near the leading-edge of the fixed section;
(ii) where the upper forward track is located above the lower forward track;
(iii) where the upper rear track and the lower rear track are located toward the trailing edge of the fixed-section;
(iv) where the upper rear track is located above the lower rear track;
(v) where the upper forward and the upper rear track together guide translation of the top moveable section;
(vi) where the lower forward and the lower rear track together guide translation of the bottom moveable section;
(vii) where all four tracks are parallel to one-another;
(viii) where all four tracks run substantially spanwise across the fixed-section.

9. The variable-span wing for aircraft according to claim 5,
(a) wherein each track-mating part comprises:
(i) one attached frame; the attached frame comprising:
(1) two or more vertically oriented threaded holes;
(ii) at least two threaded fasteners; and
(iii) one of the two driving mechanisms;
(iv) where each of the attached frames is attached to one of the movable sections near the root of the movable section;
(v) where the driving mechanism is attached to the attached frame;
(vi) where the driving mechanism translates with the moveable section;
(vii) where the heads of the at least two threaded fasteners fit within the tracks that guide translation of the track-mating part and movable section.

10. The variable-span wing according to claim 1, the variable-span wing further comprising:
(a) one or more loop driving mechanisms, each loop driving mechanism comprising of:
(i) two disc-like elements;
(ii) one loop-like element, the loop-like element comprising:
(1) an upper segment;
(2) a lower segment;
(iii) at least one driving motor;
(iv) where each of the two disc-like elements can rotate;
(v) where at least one disc-like element is driven by at least one driving motor;
(vi) where the loop-like element is disposed about each of the two disc-like elements forming the upper segment and the lower segment;
(b) where each moveable section is attached, either directly or indirectly, to the loop-like element of at least one of the one or more loop driving mechanisms;
(c) where, during rotation of the disc like element:
(i) the loop-like element moves around the periphery of the disc-like element such that the upper segment of the loop-like element moves in the opposite direction of the lower segment of the loop-like element; and
(ii) where the loop-like element moves the two moveable sections in opposing directions into and out of the fixed-section.

11. The variable-span wing according to claim 1, wherein each track-mating part (320) comprises:
(a) one or more frames;
(b) angle-sliders, the angle-sliders comprising:
(i) two approximately perpendicular planes of material;
(ii) at least one slot in each perpendicular plane;
(iii) at least one rolling element partially passing-through the at least one slot.
(c) where each one of the frames is attached to one of the movable sections near the root of the moveable section;
(d) where the rolling elements in each track-mating part fit within the tracks that guide translation of the movable section.

12. The variable-span wing according to claim 1,
(a) wherein for the set of sliding mechanisms:
(i) the at least two tracks are slot-like;
(ii) the at least two slot-like tracks run parallel to the direction of moveable-section translation;
(iii) the at least two slot-like tracks each comprise:
(1) an inset slot that does not pass all-the-way through its material;
(2) a colinear slot of lesser width that passes all-the-way through its material;
(b) where each of the at least two track-mating parts comprises at least two separated rolling elements;
(c) where the at least two separated rolling elements are disposed in one of the slot-like tracks;
(d) where ports pass through the colinear slots and rolling elements;

13. The variable span wing according to claim 3,
(a) where each of the right and left end covers further comprise:
(i) an inner face; and
(ii) an outer face;
(b) where the variable span wing further comprises:
(i) two end caps;
(ii) where each of the end caps is attached to the inner face of one of the end covers;
(iii) where the end caps are attached to the tracks at the tip edges of the tracks;
(iv) where attachment of the tracks, end caps and end covers helps to properly align and position the tracks.

14. The variable span wing according to claim 3,
(a) where the right and left end cover each further comprise:
(i) a flange; and
(ii) an inner face;
(b) where the flange protrudes inwardly from the inner face of the end cover near the periphery of the end cover;
(c) where the flange is shaped like the tip-airfoil of the fixed-section;
(d) where the flange fits into the tip opening of the fixed section;
(e) where the outer periphery of the right end cover is larger than the outer periphery of the flange so that the inner face of the right end cover interfaces with the fixed section;
(f) where the outer periphery of the left end cover is larger than the outer periphery of the flange so that the inner face of the left end cover interfaces with the fixed section.

15. The variable span wing of claim 3,
(a) further comprising a cover-to-track attaching means;
(b) where the right end cover attaches to the right tip end of at least one of the tracks with the cover-to-track attaching means, and
(c) where the left end cover attaches to the left tip end of at least one of the tracks with the cover-to-track attaching means,
(d) allowing the sliding mechanism and the two movable sections to fit securely within the fixed section between the two end covers,
(e) allowing the sliding mechanism and the two movable sections to slide out of the fixed section through one of the tip openings when at least one end cover is removed,
(f) allowing the sliding mechanism and the two movable sections to slide into the fixed section through one of the tip openings when at least one end cover is removed.

16. A non-overlapped variable-span wing for aircraft comprising:
(a) a fixed-section; the fixed-section comprising:
(i) fixed-section skin;
(1) where the fixed section skin forms a lift-generating wing surface;
(ii) fixed-section airfoils, some of the fixed-section airfoils comprising:
(1) a round leading edge; and
(2) a relatively sharp trailing edge;
(b) a top and a bottom moveable section, each movable section comprising:
(i) moveable-section airfoils, some of the moveable-section airfoils comprising:
(1) a round leading edge; and
(2) a relatively sharp trailing edge; and
(ii) A driving mechanism, the driving mechanism further comprising:
(1) at least one motor; and
(2) at least one gear head;
(3) where the at least one gear head is attached to the at least one motor;
(iii) where each motor is located near the root of the corresponding moveable section;
(iv) where each motor is attached to the moveable section or the track-mating part attached to the movable section;
(v) where the at least one motor translates with the moveable section;
(c) a set of sliding mechanisms designed to facilitate the two moveable sections to translate in substantially lateral directions into and out of the fixed-section, the set of sliding mechanisms comprising:
(i) at least two tracks; and
(ii) at least two track-mating parts;
(iii) where each track is located within the fixed-section,
(iv) where each track does not translate with the two moveable sections,
(v) where at least one of the track-mating parts is attached near the root of the top moveable section and translates along one of the tracks to guide the translation of the top movable section,
(vi) where at least one of the track-mating parts is attached near the root of the bottom moveable section and translates along at least one of the tracks to guide the translation of the bottom movable section,
(vii) where each of the tracks runs substantially spanwise across most of the fixed-section (1),
(d) at least one rack;
(i) where each rack is located within the fixed section;
(ii) where each rack does not translate with the two moveable sections;
(iii) where each gear head meshes with one of the racks;
(iv) where the rotation of each of the gear heads against one of the racks causes the two moveable sections to translate.

17. An alternative non-overlapped variable-span wing for aircraft comprising:
(a) a fixed-section (1); the fixed-section comprising:
(i) fixed-section skin;
(1) where the fixed section skin forms a lift-generating wing surface;
(ii) fixed-section airfoils, some of the fixed-section airfoils comprising:
(1) a round leading edge; and
(2) a relatively sharp trailing edge;
(b) a top and a bottom moveable section, each movable section comprising:
(i) moveable-section airfoils, some of the moveable-section airfoils comprising:
(1) a round leading edge; and
(2) a relatively sharp trailing edge; and
(c) a set of sliding mechanisms designed to facilitate the two moveable sections to translate in substantially lateral directions into and out of the fixed-section, the set of sliding mechanisms (3) comprising:
(i) at least two tracks; and
(ii) at least two track-mating parts;
(iii) where each track is located within the fixed-section;
(iv) where each track does not translate with the two moveable sections;
(v) where at least one of the track-mating parts is attached near the root of the top moveable section and translates along at least one of the tracks to guide the translation of the top movable section;
(vi) where at least one of the track-mating parts is attached near the root of the bottom moveable section and translates along at least one of the tracks to guide the translation of the bottom movable section;
(d) one or more loop driving mechanisms, each loop driving mechanism comprising:
(i) two disc-like elements;
(ii) one loop-like element; the loop-like element comprising
(1) an upper segment; and
(2) a lower segment;
(iii) at least one driving motor;
(iv) where each of the two disc-like elements can rotate,
(v) where at least one disc-like element is connected to at least one driving motor;
(vi) where the loop-like element is disposed about each of the two disc-like elements forming the upper segment and the lower segment;
(e) where each moveable section is attached to the loop-like element of one of the one or more loop driving mechanisms,
(f) where, during rotation of the disc like element:
(i) the loop-like element moves around the periphery of the disc-like element such that the upper segment of the loop-like element moves in the opposite direction of the lower segment of the loop-like element; and
(ii) where the loop-like element moves the two moveable sections in opposing directions into and out of the fixed-section.

18. An aircraft comprising:
(a) At least one fixed-section; the fixed-section comprising:
(i) fixed-section skin;
(1) where the fixed section skin forms a lift-generating wing surface;
(ii) fixed-section airfoils, some of the fixed-section airfoils comprising:
(1) a round leading edge; and
(2) a relatively sharp trailing edge;
(iii) a left tip, the left tip comprising a tip opening;
(iv) a right tip, the right tip comprising a tip opening;
(b) a top and a bottom moveable section, each movable section comprising:
(i) moveable-section airfoils, some of the moveable-section airfoils comprising:
(1) a round leading edge; and
(2) a relatively sharp trailing edge; and
(ii) where the two moveable sections are vertically offset from one another;
(iii) where the top moveable section translates in substantially lateral directions through one of the tip openings into and out of the fixed-section;
(iv) where the bottom moveable section translates in substantially lateral directions through the other tip opening into and out of the fixed-section;
(v) where the two movable sections overlap each other within the fixed-section when fully-retracted;
(vi) a set of sliding mechanisms designed to facilitate the two moveable sections to translate in substantially lateral directions into and out of the fixed-section, the set of sliding mechanisms comprising:
(1) at least two tracks; and
(2) at least two track-mating parts;
(3) where the tracks and track-mating parts facilitate the moveable sections to translate into and out of the fixed-section;
(c) a propulsion system comprising;
(i) at least two sets of a motor and a propeller;
(ii) where the at least two sets of the motor and the propeller are located forward of the leading-edge of the fixed-section;
(iii) where the at least two sets of the motor and the propeller are symmetrically disposed about the aircraft's plane-of-symmetry;
(iv) where at least one set of the motor and propeller lies on the left side of the aircraft;
(v) where at least one set of the motor and propeller lies on the right side of the aircraft; and
(vi) where the at least one set of the motor and the propeller lying on the right side of the aircraft rotate opposite to the at least one set of the motor and the propeller lying on the left side of the aircraft;
(d) at least one set of two elevons, where the two elevons:
(i) are symmetrically disposed about the aircraft's plane of symmetry;
(ii) are located near the trailing-edge of the fixed-section;
(iii) are at least partially immersed in propulsive slipstreams;
(iv) deflect symmetrically for pitch-control;
(v) deflect differentially for roll control.

19. The aircraft according to claim 18, further comprising:
(a) at least one pair of fins, each fin comprising:
(i) a fin tip;
(b) where the at least one pair of fins are symmetrically disposed about the aircraft's plane-of-symmetry.
